(19) United States
(12) Patent Application Publication
(10) Pub. No.: US 2026/0105590 A1
(43) Pub. Date: Apr. 16, 2026

(54) SYSTEM, METHOD, AND COMPUTER DEVICE FOR AGGREGATE THRESHOLDING, ADAPTIVE CROPPING, AND CLASSIFICATION OF IMAGES FOR ANOMALY DETECTION IN MACHINE VISION APPLICATIONS

(71) Applicant: Musashi AI North America Inc., Waterloo (CA)

(72) Inventor: Saeed Bakhshmand, Waterloo (CA)

(21) Appl. No.: 19/114,977

(22) PCT Filed: Oct. 4, 2023
(86) PCT No.: PCT/CA2023/051317

§ 371 Date: Mar. 25, 2025

Related U.S. Application Data
(60) Provisional application No. 63/413,056, filed on Oct. 4, 2022.

(51) Int. Cl. G06T 7/00; G06V 10/25; G06V 10/26; G06V 10/28; G06V 10/32; G06V 10/34; G06V 10/764; G06V 10/82; G06V 20/70

(52) U.S. Cl. CPC G06T 7/001; G06V 10/25; G06V 10/26; G06V 10/28; G06V 10/32; G06V 10/34; G06V 10/764; G06V 10/82; G06V 20/70; G06T 2207/10016; G06T 2207/20084; G06T 2207/20132; G06T 2207/20224

(57) ABSTRACT

Systems and methods for visual inspection and anomaly detection are provided herein. An inspection image is compared to a golden sample image to identify an anomaly map. Aggregate thresholding is performed on the anomaly map to identify anomalies. Adaptive cropping is performed on the identified anomalies to obtain cropped images of the anomalies. The cropped images are provided to an image classification model which is a pseudo one-class classifier. The image classification model classifies the anomalies.

### TECHNICAL FIELD

The following relates generally to machine learning-based visual inspection, and more particularly to visual inspection of images for anomaly detection and improvements in same.

### INTRODUCTION

Image analysis, anomaly detection, and like procedures often require significant computational resources in order to thoroughly analyze each part of an input image. Such significant computational resources can be prohibitive both as a function of cost and time when not all of an input image has the potential to be useful or reveal valuable information.

Conventional image analysis techniques may fail when multi-object images are provided to a classifier. Conventional image cropping techniques lose contextual information such as size and dimension ratio of cropped anomalies. Conventional classifiers fail to detect novel defects.

Conventional deep-learning algorithms may require inordinately large volumes of training data and may still be unable to perform reliably in tasks outside the scope of the training data.

Similarly, as anomaly detection and analysis evolve, false positives may arise where regions of an input image and/or the background thereof may be identified as anomalies of a certain class with low confidence scores. Where these low confidence scores abound, the computer systems and devices that perform such anomaly detection waste further computational resources identifying such detected anomalies as new and may wastefully initiate further downstream operations triggered by the detection of a new anomaly. This can be particularly problematic in visual inspection operations where the time for inspecting an object is limited, such as in manufacturing quality control applications or the like.

Accordingly, there is a need for a system, method, and device that overcomes at least some of the disadvantages of existing systems and methods for visual inspection and anomaly detection.

### SUMMARY

Systems and methods for anomaly detection in machine vision applications, such as visual inspection, are provided. Also provided are novel techniques for aggregate thresholding, adaptive cropping, and image classification for use in anomaly detection and machine vision applications.

In an aspect, a machine vision anomaly detection method is provided. An inspection image (e.g., of an object or article under visual inspection) is compared to a golden sample image. An image subtraction operation is performed using the inspection image and golden sample image to obtain a subtracted image. An image thresholding operation is performed on the subtracted image to identify anomalies corresponding to artifacts present in the inspection image but not in the golden sample image. The anomalies may be defined by bounding boxes. Anomalies identified via the thresholding operation are cropped using a cropping operation to obtain a cropped image that contains the anomaly. Cropped images are provided to a trained image classifier. The image classifier classifies the cropped image (and thus the anomaly contained in the cropped image) into an anomaly class and assigns a class label for the anomaly class to the anomaly. An annotated inspection image may be generated using the output of the image classification process. For example, anomalies in the inspection image may be localized using a bounding box and the bounding box may be labelled with the assigned anomaly class label. The annotated inspection image may be displayed in a user interface for review or may be used downstream in a comparison process in which the annotated inspection image is compared to an output of an object detection process performed on the inspection image. Location data for anomalies in the annotated inspection image (e.g., bounding box coordinates, centroid values) may be compared with location data for objects (e.g., defects) detected using the object detection process. Comparison of outputs from the anomaly detection and object detection processes may enable confirmation of detected objects (e.g., defects) and increase overall effectiveness of the machine vision system.

In an embodiment, the image thresholding operation is an aggregate thresholding process as described herein.

In an embodiment, the region cropping operation is an adaptive region cropping process as described herein.

In an embodiment, the image classifier is a pseudo one-class classifier as described herein. The image classifier may be configured to classify an anomaly as an abnormal deviation, a normal deviation, or a novel deviation. Novel deviations may be considered true anomalies that a semi-supervised classification model has not seen in its training dataset.

In an embodiment, a system for inspecting an inspection image is provided. The system includes a memory for receiving or storing the inspection image, a golden sample generator for generating the golden sample image from the inspection image, an image subtraction module for generating a subtracted image from the inspection image and the golden sample image, an aggregate thresholding module for generating an aggregate threshold image for identifying anomalies, an adaptive region cropping module for obtaining cropped images of the anomalies, and a cropped image classification module for classifying the cropped images of the anomalies with a pseudo-one-class classifier.

The system may further include a camera configured to capture the inspection image.

The inspection image may show a part or object under inspection or a section of region thereof.

The inspection image may be part of a video taken by the camera device.

The inspection image may be analyzed for the presence of defects.

The system may further include an adaptive ROI segmentation module for masking the inspection image and the golden sample image.

The system may further include a shape analysis and binarization module for receiving the subtracted image and generating a shape-analyzed and binarized image.

The shape analysis and binarization module may perform binarization and binary image processing to filter out defects and anomalies smaller than specified and/or caused by minor surface texture variations in the subtracted image.

The binary image processing may include erosion and delusion.

In an embodiment, a method of inspecting an inspection image is provided. The method includes acquiring the inspection image, generating a golden sample image from the inspection image, performing an image subtraction operation on the inspection image and the golden sample image to obtain a subtracted image, performing aggregate thresholding on the subtracted image to generate an aggregate threshold image for identifying anomalies, performing adaptive cropping on the aggregate threshold image to obtain cropped images of the anomalies, and classifying the cropped images of the anomalies with a pseudo-one-class classifier.

The method may further include annotating the aggregate threshold map.

The method may further include discarding parts with anomalies detected and/or confirmed in the aggregate threshold image.

The aggregate threshold map may include a bounding box enclosing each anomaly.

The method may further include identifying each region defined by each bounding box.

In an embodiment, a device for inspecting an inspection image is provided, the device including a memory for receiving or storing the inspection image, a golden sample generator for generating the golden sample image from the inspection image, an image subtraction module for generating a subtracted image from the inspection image and the golden sample image, an aggregate thresholding module for generating an aggregate threshold image for identifying anomalies, an adaptive region cropping module for obtaining cropped images of the anomalies, and a cropped image classification module for classifying the cropped images of the anomalies with a pseudo-one-class classifier.

The golden sample image generator may include a generative model.

The generative model may be an autoencoder.

The autoencoder may include an encoder component for compressing the inspection image to produce a code component and a decoder component for reconstructing the inspection image using the code component.

The golden sample image generator may retrieves an appropriate, pre-stored golden sample image.

The golden sample image generator may receive the golden sample image.

In an embodiment, a system for aggregate thresholding is provided. The system includes an image subtraction module for generating an anomaly map from comparison between an inspection image and a golden sample image, a primary threshold map generator for obtaining a first threshold map using a first threshold on the anomaly map, a processed primary threshold map generator for processing the first threshold map to obtain a processed first threshold map, a secondary threshold map generator for obtaining a second threshold map using a second threshold on the anomaly map, and an aggregate threshold map generator for aggregating the first and second threshold maps according to a set of one or more aggregation rules to obtain an aggregate threshold map.

The system may further include a camera configured to capture the inspection image.

The system may further include an adaptive ROI segmentation module for masking the inspection image and the golden sample image.

The system may further include a shape analysis and binarization module for receiving the subtracted image and generating a shape-analyzed and binarized image by performing binarization and binary image processing to filter out defects and anomalies smaller than specified and/or caused by minor surface texture variations in the subtracted image, the binary image processing including erosion and delusion.

The first threshold may be set by a user.

The second threshold may be set by a user.

The first threshold may be more conservative than the second threshold.

In an embodiment, a method for aggregate thresholding is provided. The method includes providing an anomaly map generated from comparison between an inspection image and a golden sample image, performing a first image thresholding operation on the anomaly map using a first threshold to obtain a first threshold map, processing the first threshold map to obtain a processed first threshold map, performing a second image thresholding operation on the anomaly map using a second threshold to obtain a second threshold map, and aggregating the first and second threshold maps according to a set of one or more aggregation rules to obtain an aggregate threshold map.

The method may further include discarding parts with anomalies detected and/or confirmed in the aggregate threshold image.

The aggregate threshold map may include a bounding box enclosing each anomaly.

The first threshold may be set by a user.

The second threshold may be set by a user.

The first threshold may be more conservative than the second threshold.

In an embodiment, a device for aggregate thresholding is provided. The device includes an image subtraction module for generating an anomaly map from comparison between an inspection image and a golden sample image, a primary threshold map generator for obtaining a first threshold map using a first threshold on the anomaly map, a processed primary threshold map generator for processing the first threshold map to obtain a processed first threshold map, a secondary threshold map generator for obtaining a second threshold map using a second threshold on the anomaly map, and an aggregate threshold map generator for aggregating the first and second threshold maps according to a set of one or more aggregation rules to obtain an aggregate threshold map.

The golden sample image generator may include a generative model. The generative model may include an autoencoder including an encoder component for compressing the inspection image to produce a code component and a decoder component for reconstructing the inspection image using the code component.

The golden sample image generator may retrieve an appropriate, pre-stored golden sample image.

The golden sample image generator may receive the golden sample image.

The first threshold may be set by a user.

The second threshold may be set by a user.

The first threshold may be more conservative than the second threshold.

In an embodiment, a system for adaptive region cropping is provided. The system includes an adaptive cropping region module for receiving an aggregate threshold map based on an inspection image, the adaptive cropping region module including or implemented on a processor and a memory having computer-executable instructions stored thereon that, when executed, cause the processor to perform the following operations, for each bounding box-defined region in the aggregate threshold map, applying an expansion factor to the bounding box-defined region to obtain an expanded selection having an expansion size, where an image classification model input size is less than or equal to the expansion size, resizing and downsizing an expanded selection to image classification model input size and providing the resized and/or downsized expanded selection, where an image classification model input size is not less than or equal to the expansion size, zero-padding the expanded selection to an input size of an image classification model and providing the zero-padded expanded selection.

The expansion factor may be expansion size=(16^{(length-input)/(0.88*input)}+1)×length, where ‘input’refers to the image classification model input size.

Resizing and downsizing may proceed according to the formula cropping size=min(input, expansion size), where ‘input’ refers to the image classification model input size.

The system may further include a collision avoidance module for limiting cropping coordinates to remain inside the inspection image.

The system may further include a down-sampling module for down-sampling the aggregate threshold map when an anomaly blob shown therein is larger than the image classification model input size.

The aggregate threshold map may include bounding boxes enclosing each anomaly blob.

The inspection image may be captured by a camera.

In an embodiment, a method for adaptive region cropping is provided, the method including providing an aggregate threshold map, for each bounding box-defined region in the aggregate threshold map based on an inspection image, applying an expansion factor to the bounding box-defined region to obtain an expanded selection having an expansion size, where an image classification model input size is less than or equal to the expansion size, resizing and downsizing an expanded selection to image classification model input size and providing the resized and/or downsized expanded selection, where an image classification model input size is not less than or equal to the expansion size, zero-padding the expanded selection to an input size of an image classification model and providing the zero-padded expanded selection.

The expansion factor may be expansion size=(16^{(length-input)/(0.88*input)}+1)×length, where ‘input’refers to the image classification model input size.

Resizing and downsizing may proceed according to the formula cropping size=min(input, expansion size), where ‘input’ refers to the image classification model input size.

The method may further include performing collision avoidance by limiting cropping coordinates to remain inside the inspection image.

The method may further include down-sampling the aggregate threshold map when an anomaly blob shown therein is larger than the image classification model input size.

The aggregate threshold map may include bounding boxes enclosing each anomaly blob.

The inspection image may be captured by a camera.

In an embodiment, a device for adaptive region cropping is provided. The device includes an adaptive cropping region module for receiving an aggregate threshold map based on an inspection image, the adaptive cropping region module including or implemented on a processor and a memory having computer-executable instructions stored thereon that, when executed, cause the processor to perform the following operations, for each bounding box-defined region in the aggregate threshold map, applying an expansion factor to the bounding box-defined region to obtain an expanded selection having an expansion size, where an image classification model input size is less than or equal to the expansion size, resizing and downsizing an expanded selection to image classification model input size and providing the resized and/or downsized expanded selection, where an image classification model input size is not less than or equal to the expansion size, zero-padding the expanded selection to an input size of an image classification model and providing the zero-padded expanded selection.

The expansion factor may be expansion size=(16^{(length-input)/(0.88*input)}+1)×length, where ‘input’refers to the image classification model input size.

Resizing and downsizing may proceed according to the formula cropping size=min(input, expansion size), where ‘input’ refers to the image classification model input size.

The device may further include a collision avoidance module for limiting cropping coordinates to remain inside the inspection image.

The device may further include a down-sampling module for down-sampling the aggregate threshold map when an anomaly blob shown therein is larger than the image classification model input size.

The aggregate threshold map may include bounding boxes enclosing each anomaly blob.

In an embodiment, a system for classifying an input image according to a pseudo-one-class classifier is provided. The system includes a cropped image classification module including a classifier model, the cropped image classification module including or implemented on a processor and a memory having computer-executable instructions stored thereon that, when executed, cause the processor to perform the following operations, receiving a cropped image, determining with the classifier model a preliminary class label and a confidence level associated with the preliminary class label determination for the cropped image, where the preliminary class label is of a first class, comparing the confidence level of the preliminary class label determination to a first confidence threshold, where the confidence level meets the first confidence threshold, assigning a final class label to the cropped image indicating the first class, where the confidence level does not meet the first confidence threshold, assigning a final class label to the cropped image indicating a novel class, where the preliminary class label is of a second class, comparing the confidence level of the preliminary class label determination to a second confidence threshold, where the confidence level meets the second confidence threshold, assigning a final class label to the cropped image indicating the second class, where the confidence level does not meet the second confidence threshold, assigning a final class label to the cropped image indicating the novel class.

The first confidence level may be set by a user.

The second confidence level may be set by a user.

The image classifier model may be a convolutional neural network.

The first class may represent normal deviations. The second class may represent abnormal deviations. The novel class may represent novel deviations.

Meeting a confidence level may include equaling the confidence level and may further include exceeding the confidence level.

Meeting a confidence level may include exceeding the confidence level and may not include equaling the confidence level.

In an embodiment, a method of classifying an input image according to a pseudo-one class classifier is provided. The method includes providing a cropped image, determining with a classifier model a preliminary class label and a confidence level associated with the preliminary class label determination for the cropped image, where the preliminary class label is of a first class, comparing the confidence level of the preliminary class label determination to a first confidence threshold, where the confidence level meets the first confidence threshold, assigning a first final class label to the cropped image indicating the first class, where the confidence level does not meet the first confidence threshold, assigning a second final class label to the cropped image indicating a novel class, where the preliminary class label is of a second class, comparing the confidence level of the preliminary class label determination to a second confidence threshold, where the confidence level meets the second confidence threshold, assigning a third final class label to the cropped image indicating the second class, where the confidence level does not meet the second confidence threshold, assigning the second final class label to the cropped image indicating the novel class.

The first confidence level may be set by a user.

The second confidence level may be set by a user.

Meeting a confidence level may include equaling the confidence level and may further include exceeding the confidence level.

Meeting a confidence level may include exceeding the confidence level and may not include equaling the confidence level.

The method may further include generating a second annotated inspection image using the final class label.

The method may further include flagging parts for review based on the final class label.

In an embodiment, a device for classifying an input image according to a pseudo-one-class classifier is provided. The device includes a cropped image classification module including a classifier model, the cropped image classification module including or implemented on a processor and a memory having computer-executable instructions stored thereon that, when executed, cause the processor to perform the following operations, receiving a cropped image, determining with the classifier model a preliminary class label and a confidence level associated with the preliminary class label determination for the cropped image, where the preliminary class label is of a first class, comparing the confidence level of the preliminary class label determination to a first confidence threshold, where the confidence level meets the first confidence threshold, assigning a final class label to the cropped image indicating the first class, where the confidence level does not meet the first confidence threshold, assigning a final class label to the cropped image indicating a novel class, where the preliminary class label is of a second class, comparing the confidence level of the preliminary class label determination to a second confidence threshold, where the confidence level meets the second confidence threshold, assigning a final class label to the cropped image indicating the second class, where the confidence level does not meet the second confidence threshold, assigning a final class label to the cropped image indicating the novel class.

The first confidence level may be set by a user.

The second confidence level may be set by a user.

Meeting a confidence level may include equaling the confidence level and may further include exceeding the confidence level.

Meeting a confidence level may include exceeding the confidence level and may not include equaling the confidence level.

The image classifier model may be a convolutional neural network.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for visual inspection including anomaly detection, according to an embodiment;

FIG. 2 is a block diagram of a computing device of the present disclosure, according to an embodiment;

FIG. 3 is a block diagram of a computer system for visual inspection including anomaly detection, according to an embodiment;

FIG. 4 is a schematic representation of an aggregate thresholding process, according to an embodiment;

FIG. 5 is a schematic representation of an adaptive cropping process, according to an embodiment;

FIG. 6A is a diagram showing a set of cropped images classified by a pseudo one-class classifier of the present disclosure, according to an embodiment;

FIG. 6B is a diagram showing the set of cropped images of FIG. 6A classified by a binary classifier;

FIG. 6C is a diagram showing the set of cropped images of FIGS. 6A and 6B classified by a one-class classifier;

FIG. 7 is a block diagram of an anomaly detection pipeline of the present disclosure, which may be performed by the computer system of FIG. 3, according to an embodiment;

FIG. 8 is a flow diagram of a method of visual inspection including anomaly detection, according to an embodiment;

FIG. 9 is a flow diagram of a method of aggregate thresholding for use in machine vision anomaly detection, according to an embodiment;

FIG. 10 is a flow diagram of a method of adaptive region cropping for use in machine vision anomaly detection, according to an embodiment; and

FIG. 11 is a flow diagram of a method of classifying an anomaly in a cropped image using a pseudo one-class classifier for use in machine vision anomaly detection, according to an embodiment;

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistants, cellular telephone, smartphone, or tablet device.

Each program is preferably implemented in a high-level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to machine vision applications, and more particularly to anomaly detection techniques for use in machine vision applications, such as automated visual inspection.

The present disclosure provides new advancements in deep learning for visual inspection.

Deep learning solutions deliver high customer-value and continue to be widely implemented for vision inspection applications. New advancements in deep learning model architectures are creating better performing inspection software while significantly reducing the amount of data required for solution development.

In order to do robust inspection, deep learning algorithms usually require large volumes of training data. This is especially true if supervised-learning algorithms and models are used for inspection. Although large quantities of defect data can result in reliable object detection, segmentation and classification networks, it is presumed unrealistic by many customers to wait for the accumulation of a large dataset to train a reliable Al model. Large datasets often result in prolonged project lead times and customer dissatisfaction. More importantly, there is no guarantee that a supervised deep learning model would be able to correctly detect defects that fall outside of its training dataset.

Therefore, a new set of deep learning and Al algorithms have been created to augment visual inspection software. Unsupervised algorithms and more specifically anomaly detection, are well equipped to deal with unknown and less frequent types of defects in production environments.

In order to have low false positives and still have an accurate map of anomalies, the present disclosure provides a two-step thresholding called adaptive or aggregate thresholding. This adaptive or aggregate thresholding method can take into account desired measurements of defective areas (e.g., length, width, area) and only report anomalies within given specifications.

The present disclosure also provides methods of adaptive cropping. The adaptive cropping technique of the present disclosure may provide for increased accuracy of the classification networks used in the anomaly detection visual inspection systems and methods of the present disclosure. The adaptive cropping method determines a dynamic window and zero-padding area for the images. As a result, only areas of the image which possess necessary contextual information for the next step (i.e., image classification) are preserved.

The present disclosure also provides a novel classifier for use in anomaly detection visual inspection (pseudo-one class classifier). The classifier can reliably separate products'normal surface variation from abnormal occurrences (tiny defects to large debris or dirt). This enables the anomaly detection system to accept complex parts with inconsistent visual appearance, to have no dependency on defective data, and to still maintain high recall and precision rates.

While the present disclosure describes systems and methods for anomaly detection and visual inspection of objects, the systems, methods, and devices provided herein may have further applications and different uses beyond those described herein, whether in the context of defect detection and visual inspection of objects or otherwise. Computational devices herein described as configured for anomaly detection may have functions other than anomaly detection. Input data may vary in those cases, as may output data, but elements of the present disclosure, such as aggregate thresholding, adaptive cropping, and image classification (via a pseudo one class classifier), may operate similarly.

It should be noted that while the present disclosure provides novel systems and methods for (i) aggregate thresholding, (ii) image region cropping, and (iii) image classification in anomaly detection systems, it is to be understood that the present disclosure is intended to cover embodiments of anomaly detection systems that include any one or more of (i) to (iii). In embodiments that include fewer than three of (i)-(iii), it is to be understood that, for those novel techniques not included, similar techniques may be used in their place (e.g., other forms of image region cropping rather than adaptive region cropping as described herein) to perform the general function (image thresholding, image region cropping, image classification).

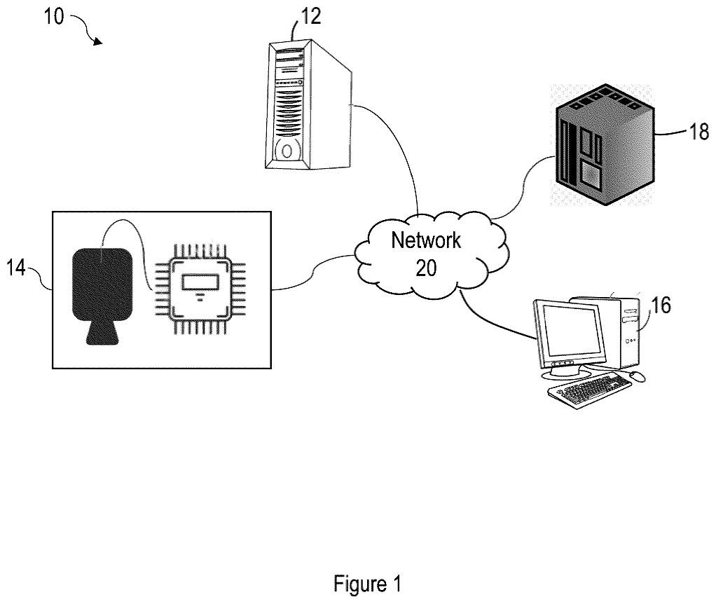

Referring now to FIG. 1, shown therein is a system 10 for visual inspection and anomaly detection, according to an embodiment. The system 10 includes an anomaly detection visual inspection device 12, which communicates with a camera device 14, a user device 16, and a control device 18 via a network 20.

The devices 12, 14, 16, 18 may be a server computer, node computing device (e.g., JETSON computing device or the like), embedded device, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. The processor may execute applications, computer readable instructions or programs. The applications, computer readable instructions or programs may be stored in memory or in secondary storage or may be received from the Internet or other network 20.

Input device may include any device for entering information into devices 12, 14, 16, 18. For example, input device may be a keyboard, keypad, cursor-control device, touchscreen, camera, or microphone. Display device may include any type of device for presenting visual information. For example, display device may be a computer monitor, a flat-screen display, a projector, or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, secondary storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

Devices 12, 14, 16, 18 can be described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, it is described below that the devices 12, 14, 16, 18 may send information to one or more other device 12, 14, 16, 18. Generally, the device may receive a user interface from the network 20 (e.g., in the form of a webpage). Alternatively, or in addition, a user interface may be stored locally at a device (e.g., a cache of a webpage or a mobile application).

The devices 12, 14, 16, 18 may be configured to receive a plurality of information, from one or more of the plurality of devices 12, 14, 16, 18.

In response to receiving information, the respective device 12, 14, 16, 18 may store the information in storage database. The storage may correspond with secondary storage of one or more other devices 12, 14, 16, 18. Generally, the storage database may be any suitable storage device such as a hard disk drive, a solid-state drive, a memory card, or a disk (e.g., CD, DVD, or Blu-ray etc.). Also, the storage database may be locally connected with the device 12, 14, 16, 18. In some cases, the storage database may be located remotely from the device 12, 14, 16, 18 and accessible to the device 12, 14, 16, 18 across a network, for example. In some cases, the storage database may comprise one or more storage devices located at a networked cloud storage provider.

The visual inspection device 12 may be a purpose-built machine designed specifically for performing any one or more of anomaly detection tasks, image analysis tasks, object (e.g., defect) detection tasks, object (e.g., defect) classification tasks, golden sample analysis tasks, object (e.g., defect) tracking tasks, other machine vision or image processing tasks that are improved here (aggregate thresholding, adaptive cropping, pseudo one class classification) and other related data processing tasks using an inspection image captured by the camera device 14.

The camera device 14 captures image data. The captured image data may be referred to as an “inspection image”. The image data may be of a part or object under inspection or a section or region thereof. The image data may include a single image or a plurality of images. The plurality of images (frames) may be captured by the camera 14 as a video. To image an area of an object to be inspected (which may also be referred to as “inspected object” or “target object”), the camera 14 and the object to be inspected may move relative to one another. For example, the object may be rotated, and a plurality of images captured by the camera 14 at different positions to provide adequate inspection from multiple angles. The camera 14 may be configured to capture a plurality of frames, wherein each frame is taken at a respective position (e.g., if the object is rotating relative to the camera 14).

Generally, the target object may be an object in which defects are undesirable. Defects in the object to be inspected may lead to reduced functional performance of the object or of a larger object (e.g., system or machine) of which the object to be inspected is a component. Defects in the object to be inspected may reduce the visual appeal of the article. Discovering defective products can be an important step for a business to prevent the sale and use of defective articles and to determine root causes associated with the defects so that such causes can be remedied.

The object to be inspected may be a fabricated article. The object to be inspected may be a manufactured article that is prone to developing defects during the manufacturing process. The object may be an article which derives some value from visual appearance and on which certain defects may negatively impact the visual appearance. Defects in the object to be inspected may develop during manufacturing of the object itself or some other process (e.g., transport, testing).

The object to be inspected may be composed of one or more materials, such as metal, steel, plastic, composite, wood, glass, etc.

The object to be inspected may be uniform or non-uniform in size and shape. The object may have a curved outer surface.

The object to be inspected may include a plurality of sections. Object sections may be further divided into object subsections. The object sections (or subsections) may be determined based on the appearance or function of the object. The object sections may be determined to facilitate better visual inspection of the object and to better identify unacceptably defective objects.

The object sections may correspond to different parts of the object having different functions. Different sections may have similar or different dimensions. In some cases, the object may include a plurality of different section types, with each section type appearing one or more times in the object to be inspected. The sections may be regularly or irregularly shaped. Different sections may have different defect specifications (i.e., tolerance for certain defects).

The object to be inspected may be prone to multiple types or classes of defects detectable using the system 10. Example defects types may include paint, porosity, dents, scratches, sludge, etc. Defect types may vary depending on the object. For example, the defect types may be particular to the object based on the manufacturing process or material composition of the object. Defects in the object may be acquired during manufacturing itself or through subsequent processing of the object.

The user device 16 may be configured to receive a data output generated by the visual inspection device 12 for display in a user interface. The user device 16 is configured to receive input data from a user and display an output to the user, such as data generated by the visual inspection device 12.

The control device 18 is configured to control the manipulation and physical processing of the target object. This may be done by sending and receiving control instructions to an article manipulating unit (not shown) via a communication link. Such manipulation and physical processing may include rotating or otherwise moving the target object for imaging and loading and unloading objects to and from an inspection area. An example instruction sent by the control unit 18 to the article manipulating unit via the communication link may be “rotate target article by ‘n’ degrees”. In some cases, the transmission of such instruction may be dependent upon information received from the visual inspection device 12. The control device 18 may be configured to generate and send a control signal to control the action of one or more components of a visual inspection machine. Such control signal may be determined based on an output of the visual inspection device 12. The control device 18 may also communicate with and control operation of any one or more of devices 12, 14, 16.

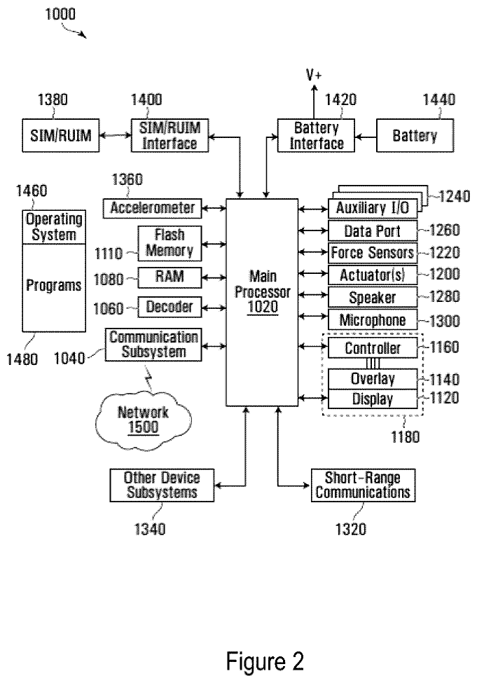

Referring now to FIG. 2, shown therein is a block diagram of a computing device 1000 of the system 10 of FIG. 1, according to an embodiment. The computing device 1000 may be, for example, any one of devices 12, 14, 16, 18 of FIG. 1.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g., with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a computing device generated by the processor 1020 may be displayed on the touch-sensitive display 1180.

The processor 1020 may also interact with an accelerometer 1360. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1110 or performed using other techniques.

The computing device 1000 also includes an operating system 1460 and software components 1480 that are executed by the processor 1020 and which may be stored in a persistent data storage device such as the flash memory 1110. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

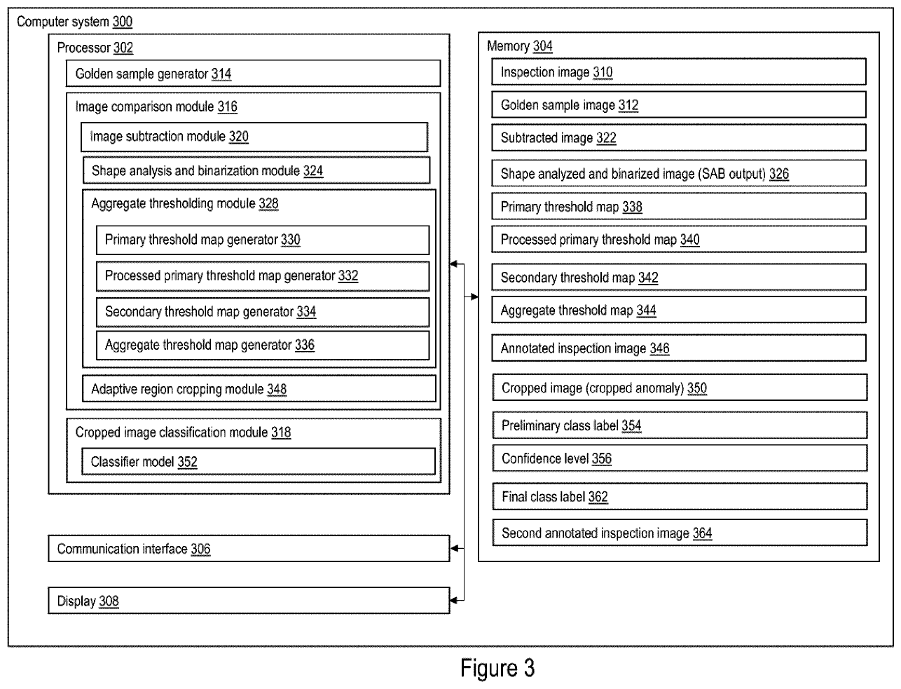

Referring now to FIG. 3, shown therein is a computer system 300 for automated visual inspection including anomaly detection, according to an embodiment. The computer system 300 may be implemented at one or more devices of the system 10 of FIG. 1. For example, the computer system 300, or components thereof, may be implemented at any one or more of the visual inspection device 12, user device 16, and control device 18 of FIG. 1. The system 300 may function as an anomalous defect detector and anomaly classifier.

The system 300 includes a processor 302 for executing software models and modules.

The system 300 further includes a memory 304 in communication with the processor 302 for storing data, including output data from the processor 302.

The system 300 further includes a communication interface 306 for communicating with other devices, such as through receiving and sending data via a network connection (e.g., network 20 of FIG. 1).

The system 300 further includes a display 308 for displaying various data generated by the computer system 300 in human-readable format. For example, the display may be configured to display results of an inspection of the object to be inspected. The display 308 may be implemented at the user device 16 of FIG. 1.

The memory 304 stores an inspection image 310 comprising image data. The inspection image 310 may be of a target object under inspection. The inspection image 310 may be received by the system 300 via the communication interface 306. The inspection image 310 may be generated and provided by the camera 14 of FIG. 1 or may be received from some other source (e.g., networked device, external storage device, etc.).

The memory 304 also stores a golden sample image 312. Generally, the golden sample image 312 is an idealized representation of the inspection image 310 (or region of interest indicated by the input, such as in the case of a masked inspection image). The golden sample image 312 may represent an image of an object or part without any defects or improper assembly so that a comparison may be made between the golden sample image 312 of the inspection image 310 and the inspection image 310 to identify defects or anomalies in the inspection image 310 (and thus in the object or part captured in the inspection image 310). Generally, comparison between the inspection image 310 and the golden sample image 312 facilitates identification of differences, which can then be analyzed to determine the presence of anomalies.

The golden sample image 312 may be generated by the computer system 300. For example, in some embodiments, the computer system 300 includes a golden sample generator module 314 for generating the golden sample image 312 using the inspection image 310. In an embodiment, the golden sample generator module 314 includes a generative model (not shown). The generative model receives the inspection image 310 as input and generates the golden sample image 312 as output.

The generative model may be an autoencoder, such as a variational autoencoder. The generative model is configured to generate a golden sample image 312 from the inspection image 310. A golden sample image 312 generated using the generative model may be considered a “generative golden sample”. In other embodiments, non-generative golden sample images may be used. In an autoencoder embodiment, the generative model may include an encoder component, a code component, and a decoder component (not shown). The encoder component compresses an input (inspection image 310) and produces the code component. The decoder component reconstructs the input using only the code component. In this case, the term “reconstruct” refers to a reconstruction of a representation of the inspection image 310 which has less noise than the inspection image 310. Preferably, the reconstructed representation is noiseless. The reconstructed representation is the golden sample image 312 for the given inspection image 310 used as input to the generative model. The generative model may include an encoding method, a decoding method, and a loss function for comparing the output with a target. Generally, the generative model receives an inspection image 310 that is a mixture of noisy and noiseless data. The generative model may be trained using a training process which helps to set weights of the model so that the model knows what is noise and what is data. Once trained, the generative model can be sent a noisy inspection image 310 and generate a noiseless (or less noisy) image at the output (i.e., a golden sample image 312). The noise removed from the inspection image 310 may be defects or any other deviation (e.g., deviation from a machined surface that is deemed as normal). The noise present in the inspection image 310 and which the generative model is configured to remove may have various sources. The noise may be, for example, different types of defects or anomalous objects, droplets (of liquids) or stains from such liquids. Factory and other manufacturing facility environments and air therein are generally not clean and as a result there is a chance of having metal pieces, coolant residue, oil droplets, or the like left on a target article (e.g., camshaft) after machining (e.g., CNC machining) and sitting on the floor for an extended period of time. Further, the target article may be washed or covered with protective material such as rust-inhibitors or oil.

In other embodiments, the memory 304 may store a bank of golden sample images from which to retrieve the appropriate golden sample image 312 (i.e., a non-generative golden sample).

In other embodiments, the golden sample image 312 may not be generated by the system 300 is rather received from an external device via the communication interface 306. For example, the golden sample image 312 may be received from a networked device or an external storage device. In such embodiments, the system 300 may not include the golden sample generator 314.

The processor 302 further includes an image comparison module 316 and a cropped image classification module 318. The image comparison module 316 is configured to compare the inspection image 310 and golden sample image 312 and generate an output, which is provided to the classification module 318 for classification.

The image comparison module 316 performs a direct image comparison of the inspection image 310 and the golden sample image 312 (or of masked versions of 310, 312 as described herein) and generates comparison output data. The comparison output data may include one or more detected anomalies (or artifacts). A detected anomaly in this context refers to an artifact or anomaly present in the inspection image 310 and not in the golden sample image 312. In other words, the detected artifact or anomaly represents a detected difference between the images 310, 312.

The image comparison module 316 includes an image subtraction module 320.

The image subtraction module 320 is configured to receive the inspection image 310 and golden sample image 312 as inputs and perform an image subtraction operation to generate a subtracted image 322 as output.

For example, the image subtraction module 320 may subtract the digital numeric value of pixels in the images 310, 312. In an embodiment, the images 310, 312 may be compared using matrix subtraction or pixel to pixel greyscale subtraction to generate an output identifying the artifacts. The image subtraction module 320 may compare the images 310, 312 on a pixel-by-pixel basis. The subtracted image 322 is stored in memory 304. The subtracted image 322 may be considered an “anomaly map” (as the subtraction process identifies differences in the images 310, 312, which may be considered anomalies).

In some embodiments, the inspection image 310 and golden sample image 312 may be masked prior to image subtraction and the image subtraction performed on the masked versions of the images 310, 312. Masking may include masking or covering regions “not of interest” (nROIs) in the respective images. In doing so, analyzed images may be limited to regions of interest (“ROIs”). This may minimize false positives and use computer resources more efficiently. nROIs may include non-uniform areas of the inspection image in which the object to be inspected is depicted. Non-uniform areas may include components of a target object whose appearance may vary from one article to another and that are not the subject of or relevant to the visual inspection. Such determination of relevance may be made by the user in advance or by the system 10 at the time of processing. Non-uniform areas may include improperly illuminated areas or regions. Some visual inspection tasks may require illuminating the target article. Such illumination may translate into the inspection image of the illuminated target article. In some cases, illumination may be complex, such as requiring or using multiple lighting sources. Illumination can lead to non-uniform lighting of the target article (e.g., properly illuminated or well-lit areas, improperly illuminated or poorly lit areas). Non-uniform lighting may cause problems or inefficiencies for downstream image analysis processes, such as defect and anomaly detection (e.g., by introducing false positives). By identifying and masking improperly illuminated regions that are not of interest for the visual inspection system, the system may provide improved image analysis (e.g., defect detection, anomaly detection). Non-uniform areas may further include surfaces that may potentially generate a large variety of anomalies and/or defects in image analysis, for example, textured surfaces (e.g., casting surfaces on a camshaft). Masking the regions covered by such surfaces may reduce the false positives and improve overall defect and anomaly detection.

In a particular embodiment, the inspection image 310 may be provided to an adaptive ROI segmentation module (not shown) which identifies and masks nROIs in the inspection image 310. The masking of the nROIs may be performed by setting the pixels of nROIs in the inspection image 310 to black. This may include specifically setting pixels in nROIs to black or setting all pixels in the image that are outside ROIs to black. The masked inspection image (not shown) may be provided to a generative model (not shown), which generates a masked golden sample image (not shown) from the masked inspection image. Advantageously, because nROIs have been masked in masked inspection image, the generative model does not perform its generation with respect to those regions. Accordingly, the generative model may proceed more efficiently and effectively through avoiding unnecessary processing of regions not of interest as identified by the adaptive ROI segmentation module.

Other features of adaptive region of interest segmentation as described in International patent application no. CA2022050289, which is incorporated herein by reference, may be used by the systems and methods of the present disclosure.

The image comparison module 316 includes a shape analysis and binarization module 324.

The shape analysis and binarization module 324 receives the subtracted image 322 as input and generates a shape analyzed and binarized image (SAB output) 326 as output. The SAB output 326 of the shape analysis and binarization module 324 may be referred to as an “anomaly map”. In an embodiment, the shape analysis and binarization module 324 may perform binarization, binary image processing (erosion and delusion) to filter out defects and anomalies smaller than specified and/or caused by minor surface texture variations. The shape analysis and binarization module 324 performs binarization on the subtracted image 322. The binarization includes creating a black-white image using a static threshold. The shape analysis and binarization module 324 also performs a shape analysis on the subtracted image 322. The shape analysis includes a combination of morphological operations.

The image comparison module 316 further includes an aggregate thresholding module 328 for performing an aggregate thresholding operation on the SAB output 326.

The aggregate thresholding module 328 includes a primary threshold map generator 330, a processed primary threshold map generator 332, a secondary threshold map generator 334, and an aggregate threshold map generator 336. In an embodiment, the shape analysis and binarization module 324 may be the same as or may be integral with the primary threshold map generator 330 and/or the processed primary threshold map generator 332. In an embodiment, the shape analysis and binarization module 324 is distinct from the primary threshold map generator 330 and from the processed primary threshold map generator 332, and the SAB output 326 is provided as input to the primary map generator 330.

The primary threshold map generator 330 is configured to receive an input and perform a thresholding operation on the input using a first (or primary) threshold to obtain a primary (or first) threshold map 338. The input may be the subtracted image 322 or an output of the shape analysis and binarization module 324 (e.g., SAB output 326). The threshold may be user selected. The threshold may be set by a user using the user device 16 of FIG. 1.

The primary threshold map 338 is provided to the processed primary threshold map generator 332, which generates a processed primary (or first) threshold map 340. This may include binarization, binary image processing (erosion and delusion and grouping close-by anomalies) to filter out defects smaller than specified and/or anomalies caused by minor surface texture variations.

The secondary threshold map generator 334 is configured to receive an input and perform a thresholding operation on the input using a second (or secondary) threshold to obtain a secondary (or second) threshold map 342. The threshold may be user selected. The threshold may be set by a user using user device 16 of FIG. 1. The input to the secondary threshold map generator 334 may be the subtracted image 322. The input to the secondary threshold map generator 334 may be the SAB output 326.

The primary and secondary thresholds used by the modules 330, 334, respectively, are different. Generally, the primary threshold may be considered a more conservative (lower) threshold (e.g., a very conservative threshold) and the secondary threshold may be considered a more aggressive (higher) threshold. For example, the primary threshold may be a higher number and the secondary threshold a lower number such that the primary threshold catches very dark areas in the SAB output 326 and the secondary threshold catches larger areas in the SAB output 326.

The processed primary threshold map 340 and the secondary threshold map 342 are provided to the aggregate threshold map generator 336, which aggregates the two threshold maps 340, 342 to obtain an aggregate threshold map 344.

Aggregation may be performed according to one or more aggregation rules encoded in the aggregate threshold map generator 336. For example, in an embodiment, the one or more aggregation rules include “include, in the aggregate threshold map 344, any blob in the secondary threshold 342 map that overlaps with a blob in the processed primary threshold map 340; do not include, in the aggregate threshold map 344, any blob in the second threshold map 342 that does not overlap with any blob in the processed primary threshold map 340; do not include, in the aggregate threshold map 344, any blob from the processed primary threshold map 340”. In other embodiments, the aggregation rules may vary.

Generally, the focus of the aggregate threshold map generator 336 is finding blobs that are overlapping in the two maps 340, 342. For example, the aggregate map generator 336 may look at the secondary threshold map 342 and see whether any blobs therein overlap with any blobs in the primary threshold map 340. If the blobs overlap, then the blob from the secondary threshold map 342 is included in the aggregate threshold map 344. In such a case, the number of pixels is not reduced or added, rather the whole region of the blob in the secondary threshold map 342 remains (if any portion of that blob overlaps with any portion of any blob in the processed primary map 340). The term “blob” may also be referred to as “anomaly blob” (i.e., a blob which represents an anomaly in the image).

The aggregate threshold map 344 may be used to determine location data (e.g., bounding box coordinates) for regions in the inspection image 310 that contain potential anomalies (i.e., artifacts that may be anomalies), which location data may then be used to locate or localize such regions in the inspection image 310. For example, for each blob in the aggregate threshold map 344, a bounding box may be determined. The inspection image 310 may then be annotated with the determined bounding boxes (annotated inspection image 346).

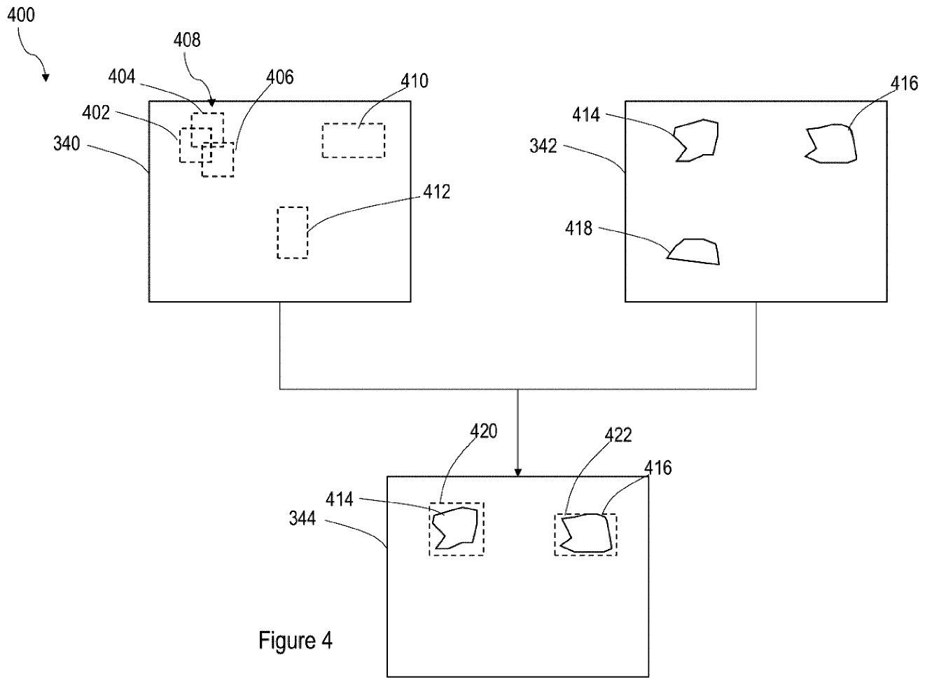

Referring now to FIG. 4, shown therein is a schematic representation of an aggregate thresholding process 400, according to an embodiment. The aggregate thresholding process 400 may be executed by the aggregate thresholding module 328 of FIG. 3.

FIG. 4 shows an example processed primary threshold map 340 and an example secondary threshold map 342. The processed primary threshold map 340 and the example secondary threshold map 342 are aggregated to obtain an aggregate threshold map 344.

The processed primary threshold map 340 includes blobs 402, 404, 406, 408, 410, and 412. Blobs 408, 410, 412 represent potential anomalies in the inspection image 310 (i.e. regions of the inspection image 310 that may be determined to contain anomalies through operation of the system 300). Blob 408 includes overlapping blobs 402, 404, and 406. Processing the corresponding primary threshold map 338 may include identifying blobs 402, 404, and 406 as overlapping and generating blob 408. In processing the primary threshold map 338 to obtain the processed primary threshold map 340, the processed primary threshold map generator 332 may remove small potential anomalies (not shown) and merge adjacent anomalies, for example merging the overlapping masked regions 402, 404, and 406 to generate the masked region 408.

The secondary threshold map 342 includes blobs 414, 416, and 418. Blobs 414, 416, 418 represent potential anomalies in the inspection image 310 (i.e. regions of the inspection image 310 that may be determined to contain anomalies through operation of the system 300).

Differences in the presence of blobs can be seen between the processed primary threshold map 340 and the secondary threshold map 342. Such differences are generally attributable to the different thresholds applied to generate each map 340, 342.

The maps 340, 342 are aggregated according to one or more aggregation rules to obtain the aggregate threshold map 344. In the embodiment of FIG. 4, the one or more aggregation rules include “include, in the aggregate threshold map 344, any blob in the secondary threshold map 342 that overlaps with a blob in the processed primary threshold map 340; do not include, in the aggregate threshold map 344, any blob in the second threshold map 342 that does not overlap with a blob in the processed primary threshold map 340; do not include, in the aggregate threshold map 344, any blob from the processed primary threshold map 340”. In other embodiments, the aggregation rules may vary. For example, while the present embodiment may allow for any overlap between a secondary blob and a primary blob, other embodiments may only include the secondary blob if the overlap amount meets a predetermined overlap threshold. Aggregation may also be referred to as “verification”.

Blobs 414, 416 in the aggregate threshold map 344 are localized by bounding boxes 420, 422, respectively, which enclose the blobs. The bounding boxes from the aggregate threshold map 344 may be used to identify regions of the inspection image 310 for subsequent operations (e.g., for cropping and classification). For example, the bounding boxes may be used to annotate the inspection image 310 and generate the annotated inspection image 346.

The aggregate thresholding process of the present disclosure may provide particular advantages, including over conventional or existing masking approaches. Conventional masking disadvantageously excludes low contrast areas of anomaly masks. For example, one-step thresholding with a low threshold value may result in high false positives. As a further example, one-step thresholding with a high threshold value may be unable to detect small, high-contrast regions. Aggregate thresholding as shown in FIG. 4 advantageously includes areas of anomaly masks of different levels of contrast. Aggregate thresholding further advantageously assists a classifier with more accurate bounding boxes for anomalies. Aggregate thresholding further advantageously eliminates false positives, i.e., anomalies with only low-contrast pixels. Aggregate thresholding further advantageously assists in improving drawing anomaly boundaries and thereby provides more context to the classifier. Aggregate thresholding may further assist in creating more accurate bounding boxes for anomalies.

Referring again to FIG. 3, the image comparison module 316 also includes an adaptive region cropping module 348.

The adaptive region cropping module 348 receives the annotated inspection image 346 as input and performs a cropping operation on the annotated inspection image 346 to obtain one or more cropped images 350.

Generally, adaptive cropping is performed to cut or extract a region or subset of the image data from the inspection image 310 for use in image classification (by the classification module 318). Generally, a cropped image 350 corresponds to a region of the inspection image 310 that contains a potential anomaly (as such, the cropped image 350 may also be referred to as a cropped anomaly 350).

The adaptive region cropping module 348 uses location data (e.g., bounding box coordinates) in the annotated inspection image 346 to perform cropping and obtain the cropped image 350.

An adaptive cropping process performed by the adaptive cropping module 348 will now be described.

First, a bounding box (e.g., from the aggregate threshold map 344 or annotated inspection image 346) is identified. The region defined by the bounding box may be referred to as a “selected region”.

An expansion factor is applied to the selected region to obtain an expansion size. In an embodiment, the expansion factor is:

Expansion size=(16^{(length-input)/(0.88*input)}+1)×length

The foregoing is one example of a formula for expansion size. In variations, the expansion size equation may change (e.g., slightly) from one application to another.

Specifically, the bounding box and/or region defined by the bounded box is expanded in order to obtain an expanded selection having an expansion size according to the above formula. In performing the expansion operation, the bounding box and corresponding cropped window is expanded. For instance, if application of an expansion formula (e.g., the above formula) produces outputs of 50 and 100 in x and y directions, respectively, the margin around the actual anomaly blob can jump from zero pixels to 50 pixels in the x direction and 100 pixels in the y direction.

In the above formula, “length” refers to width or height of the anomaly (i.e., if calculating for x direction, “length” is width, and if calculating for y direction, “length” is height). In the above formula, “input” refers to the image classifier input size (i.e., input size of a classifier model 352).

Once an expansion size is determined, a cropping size is determined by comparing the expansion size to the input size using the following formula:

$$Cropping size = min ( input , expansion size )$$

According to the above formula, the expanded image is cropped to either (i) the input size of the classifier to which the cropped image 350 is to be provided or (ii) maintained at the current expansion size, whichever is smaller.

The adaptive region cropping module 348 may perform collision avoidance once the expanded size has been determined. Collision avoidance includes limiting cropping coordinates to remain inside of the larger image (e.g., the inspection image 310). Collision avoidance may advantageously prevent the computer system 300 or software implementing same from erroring out, as the computer system 300 or software implementing same, upon attempting to crop an anomaly with a negative dimension value or a dimension value greater than respective dimensions of the inspection image 310 (x or y) may cause an error. For example, if the input size is less than or equal to the expansion size, the adaptive region cropping module 348 determines whether the expanded selection and/or the bounding box collides with other bounding boxes and/or goes beyond the bounds of the aggregate threshold map 344.

If the cropping size is determined to be the input size, the adaptive region cropping module 348 resizes and downsizes the expanded selection down to the input size.

In an embodiment, if the expansion size is equal to the input size, resizing and/or downsizing is not performed. In an embodiment, if the expansion size is equal to the input size, resizing and/or downsizing is still considered to be performed.

If the expansion size is determined to be less than the input size (i.e., cropping size=expansion size, according to the above formula), the adaptive region cropping module 348 zero-pads the expansion size (expanded selection) in order to generate a zero-padded expanded selection that is equal to the input size.

The resulting expanded image may be further downsampled. Downsampling may occur in a less-likely case where the anomaly blob is larger (in x direction, in y direction, or in both directions) than the input size to the classifier. In this scenario, the cropped image 350 is resized and shrunk to fit that fixed input size.

The adaptive region cropping module 348 repeats the foregoing functionality in respect of each additional anomaly and/or bounding-box-defined region in the aggregate threshold map 344 or annotated inspection image 346 to generate further cropped images 350.

When an image, such as the aggregate threshold map 344, is cropped according to conventional methods, contextual information such as a size and/or a dimension ratio of cropped anomalies may be lost. This may occur, for example, where the inspection image 310 is cropped according to a fixed window of model input (e.g., 224 pixels by 224 pixels) or where a more precise cropping is made of an anomaly which is then resized to the fixed window of model input.

Such expansion size may further advantageously provide sufficient context to the anomaly.

Using the adaptive cropping method of the present disclosure, the size of the anomaly advantageously remains consistent throughout the adaptive cropping.

In an embodiment, the output of the adaptive region cropping module 348 may be a set of one or more small images each corresponding to a region of the inspection image that contains a potential anomaly. In an embodiment, the output may be a batch of 224*224 images.

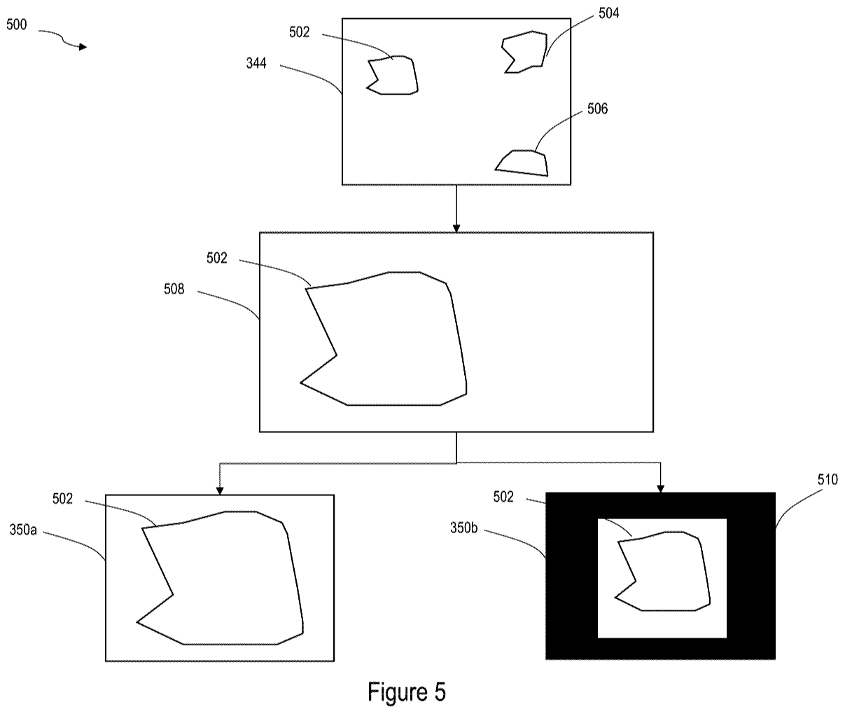

Referring now to FIG. 5, shown therein is a schematic representation of an adaptive cropping process 500 performed on an image, according to an embodiment. The adaptive cropping process 500 may be used to generate the cropped image 350. The adaptive cropping process 500 may be executed by the adaptive region cropping module 348.

The adaptive cropping process 500 starts with the aggregate threshold map 344. The aggregate threshold map 344 includes a target anomaly 502. “Target” refers to the fact that anomaly 502 is “targeted” for cropping. Providing a better and/or more detailed view of the target anomaly 502 may be the motivation for applying adaptive cropping to the aggregate threshold map 344. The aggregate threshold map 344 further includes anomalies 504, 506 that are not target anomalies and do not appear in the cropped image 350. Anomalies 504, 506 may be target anomalies in the sense that anomalies 504, 506 may be subject to their own respective cropping operation (similar to the process 500).

Expanded image data 508 of the region including the target anomaly 502 in the aggregate threshold map 344 is generated according to the formula: expansion size=(16^{(length-input)/(0.88*input)}+1)*length.

In FIG. 5, the expanded image data 508 is larger than the aggregate threshold map 344. In an embodiment, the expanded image data 508 is smaller than the aggregate threshold map 344 despite being expanded, for example because only a portion of the aggregate threshold map 344 is expanded accordingly. In an embodiment, the expanded image data 508 is identical or nearly identical in size to the aggregate threshold map 344, for example because only a portion of the aggregate threshold map 344 has been expanded and because the portion of the aggregate threshold map 344 so expanded has been selected to be expanded to an identical or nearly identical size as the aggregate threshold map 344.

The expanded image data 508 depicts the target anomaly 502 as larger. The expanded image data 508 depicts the target anomaly 502 in more detail than may be seen in the aggregate threshold map 344.

The cropped image 350 is generated from the expanded image data 508.

When the input size of the classifier model 352 is less than the expansion size, the cropping size is equal to the input size of the classifier model 352, and cropped image 350a is generated.

When the expansion size is less than the input size of the classifier model 352, the cropping size is equal to the expansion size. In order to provide a cropped image 350 equal in size to the input size of the classifier model 352, zero-padding is applied to yield a zero-padded region 510 in generated cropped image 350b.

Advantageously, adaptive cropping may provide further and sufficient background context to the cropped image 350. Adaptive cropping may preserve dimension and size of the target anomaly 502 within the cropped image 350. Accordingly, classification accuracy may be improved. Without adaptive cropping, contextual information such as size and dimension ratio of cropped anomalies may be lost.

Referring again to FIG. 3, the cropped image 350 in provided to the image classification module 318 for classification. The classification module 318 may be considered a “pseudo one-class classifier” for reasons described below and herein.

The image classification module 318 includes an image classifier model 352. The classifier model 352 may be a neural network. The neural network may be a convolutional neural network (CNN). The image classifier model 352 may be any suitable classifier model configured to perform image classification. The classifier 352 may be a combination of convolution layers (from a pre-trained CNN) and a support vector machine (“SVM”) classifier. The SVM classifier may be trained on a small set of project-specific images. With sufficient training samples, such a hybrid CNN may be swapped with a fine-tuned CNN.

The image classifier model 352 is configured to receive image data as input (i.e., the cropped image 350). In an embodiment, the image classifier model 352 is configured to classify the cropped image 350 (and thus the anomaly contained therein) as an abnormal deviation, a normal deviation, or a novel deviation. In operation, the image classifier model 352 analyzes the cropped image 350 and determines a preliminary class label 354 for the cropped image 350 and a confidence level 356 for the assignment of the preliminary class label 354. The possible preliminary class labels may include an “OK” label corresponding to an “OK” (or good) class (first label/class) and an “NG” label corresponding to an “NG” (or no good) class (second label/class). The labels may be represented in the system 300 in any suitable format (e.g., string, numerical value). The confidence level of the class label assignment may be represented in any suitable format (e.g., as a number from 0-1, with 0 being low confidence and 1 being high confidence). The preliminary class label 354 and the confidence level 356 are stored in memory 304.

Each of the preliminary classes have an associated confidence threshold. For example, the OK class has an associated OK class confidence threshold (first confidence threshold), and the NG class has an associated NG class threshold (second confidence threshold).

When the assigned preliminary class label 354 is an OK class label, the classification module 318 compares the corresponding confidence level 356 to the OK class confidence threshold to determine whether the confidence level 356 meets the confidence threshold. When the confidence level 356 meets the OK class confidence threshold, the classification module 318 assigns a final class label 362 of “OK anomaly” (representing an OK anomaly class or normal deviation class). When the confidence level 356 does not meet the OK class confidence threshold, the classification module 318 assigns a final class label 362 of “novel anomaly” (representing a “novel anomaly” or “novel deviation”class).

When the assigned preliminary class label 354 is an NG class label, the classification module 318 compares the corresponding confidence level 356 to the NG confidence threshold to determine whether the confidence level 356 meets the NG confidence threshold. When the confidence level 356 meets the NG class confidence threshold, the classification module 318 assigns a final class label 362 of “NG anomaly” (representing an NG anomaly class or abnormal deviation class). When the confidence level 356 does not meet the NG class confidence threshold, the classification module 318 assigns a final class label 362 of “novel anomaly” (representing a “novel anomaly” or “novel deviation” class). The OK class confidence threshold and the NG class confidence threshold may be different.

Confidence thresholds may be set manually by a user (e.g., human expert) as a parameter.

The classification module 318 thus compares the confidence level 356 of the assignment of the preliminary class label 354 to the appropriate confidence threshold and assigns a final class label 362. The final class label 362 is stored in memory 304. There may be more potential final class labels 362 than potential preliminary class labels 354. For example, where there are two possible preliminary class labels 354, there may be three or more possible final class labels 362. In some cases, the classes represented by the preliminary class labels 354 may be represented as classes in the final class labels 362 along with one or more additional classes not represented in preliminary class labels. In an example, the preliminary class labels may be OK anomaly and NG anomaly, and the final class labels may be OK anomaly/normal deviation, NG anomaly/abnormal deviation, and novel anomaly/novel deviation.

If the preliminary class label 354 is the first class label (OK class label) and the confidence level 356 meets the first confidence threshold (OK class confidence threshold), the cropped image 350 is assigned a first final class label 362 corresponding to a first class (e.g., OK anomaly class/normal deviation class).

If the preliminary class label 354 is the first class label (OK class label) and the confidence level 356 does not meet the first confidence threshold (OK class confidence threshold), the cropped image 350 is assigned a second final class label 362 corresponding to a second class (e.g., novel anomaly class/novel deviation class).

If the preliminary class label 354 is the second class label (NG class label) and the confidence level 356 meets the second confidence threshold (NG class confidence threshold), the cropped image 350 is assigned a third final class label 362 corresponding to a third class (e.g., NG anomaly class/novel deviation class).

If the preliminary class label 354 is the second class label (NG class label) and the confidence level 356 does not meet the second confidence threshold (NG class confidence threshold), the cropped image 350 is assigned the second final class label 362 corresponding to the second class (e.g., novel anomaly class/novel deviation class).

Thresholds such as the first and second confidence thresholds may be implemented in any manner and are preferably set manually by a user (e.g., by human experts) as a parameter. Such thresholds are generally used to denote assignment into one class or another. In an embodiment, meeting a threshold includes equaling or exceeding the threshold. In an embodiment, meeting a threshold means strictly exceeding the threshold.

In some embodiments, the evaluation of the preliminary class label 354 in respect of the confidence thresholds may be performed by the classifier model 352 (and the classifier model is configured as such). In other embodiments, the evaluation of the preliminary class label 354 in respect of the confidence thresholds may be performed by the classification module 318 using instructions or logic external to the classifier model 352 that are used to process the output of the classifier model 352.

The processor 302 may then generate a second annotated inspection image 364 using the final class label 362 and location data from the annotated inspection image 346.

For example, the processor 302 may generate an inspection image in which each region identified for cropping and classification has been defined by a bounding box and labelled with the final class label 362 (second annotated inspection image 364). The bounding box data may come from the aggregate threshold map 344 or the annotated inspection image 346. The second annotated inspection image 364, when displayed in a user interface, may identify anomalies in the inspection image 310 and their respective assigned class such that a user can review. In some embodiments, the processor 302 may be configured to generate a user interface including the second annotated inspection image 364 and display the user interface via the display 308.

The foregoing classification module 318 (pseudo one-class classifier) may provide particular advantages, including over other types of classifiers such as one-class and binary classifiers. The classifier may enable conversion of a multi-class (or binary) classifier into a true anomaly detector. The classifier may provide reliable detection of well-known defects (if available). The classifier may be capable of starting autonomous inspection without defective parts. In particular, a binary OK versus NG classifier can miss detecting novel defects and as a result an anomaly detection system and algorithm incorporating same may miss defects that look like OK anomalies.

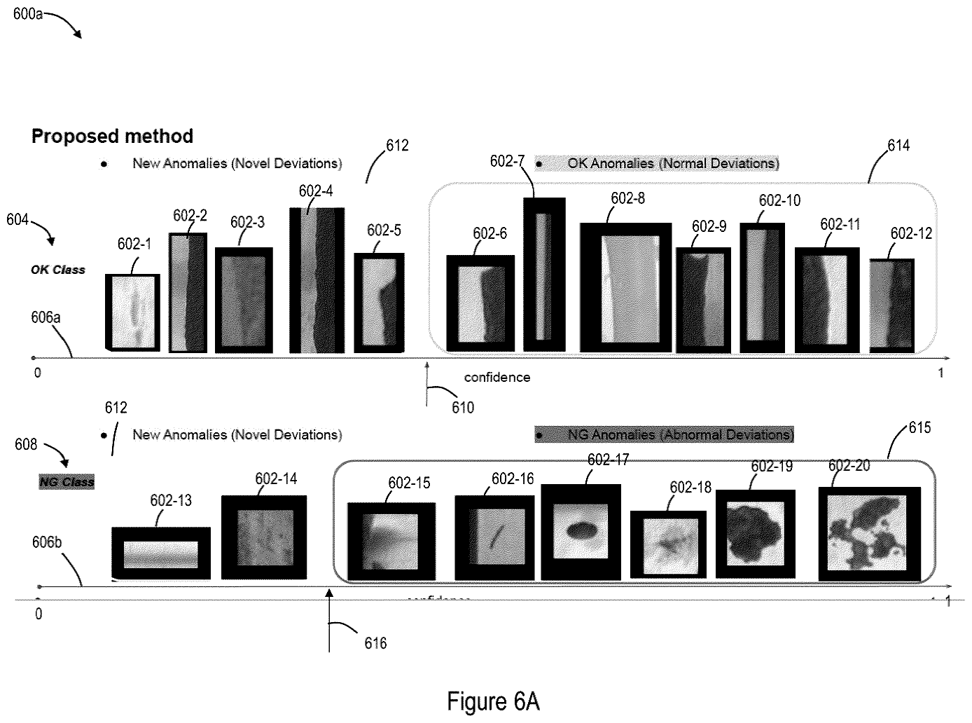

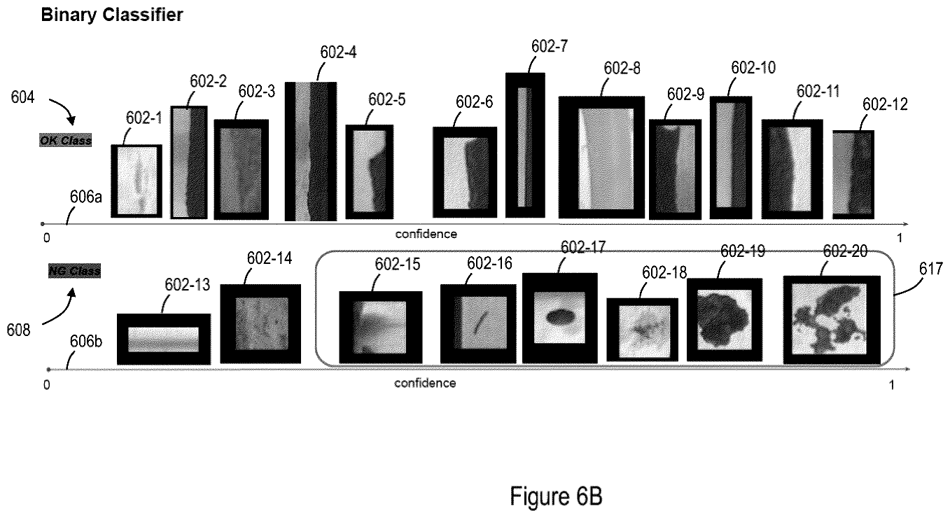

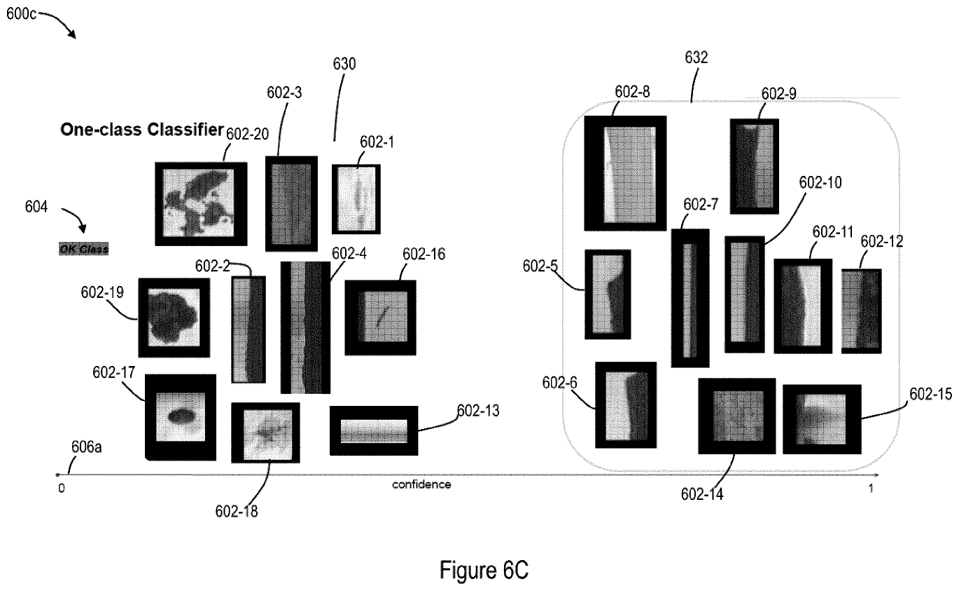

Referring now to FIGS. 6A-6C, shown therein are a set of cropped images classified by a pseudo one-class classifier of the present disclosure (FIG. 6A) according to an embodiment, by a binary classifier (FIG. 6B), and by a one-class classifier (FIG. 6C). The classification outputs shown in FIGS. 6A-6C may be generated by the classification module 318 of FIG. 3.

Referring first to FIG. 6A, FIG. 6A shows classification results 600a for cropped images 602-1 to 602-20. The classifier of FIG. 6A has first classified images 602-1 to 602-12 into an OK class 604 (preliminary class label) with an associated confidence level 606a and images 602-13 to 602-20 into an NG class 608 (preliminary class label) with an associated confidence level 606b. Images 602-1 to 602-20 are referred to collectively as images 602 and generically as image 602.

The images classified that have been classified into the OK class 604 are further evaluated with respect to a first confidence threshold 610. The images 602 assigned to the OK class 604 with a confidence level below the threshold 610 are assigned to a novel anomaly (novel deviation) class 612 (final class label). The images 602 assigned to the OK class 604 with a confidence level that meets the threshold 610 are assigned to an OK anomaly (normal deviation) class 614.

The images that have been assigned to the NG class 608 are further evaluated with respect to a second confidence threshold 616. The images 602 assigned to the NG class 608 with a confidence level below the threshold 616 are assigned to the novel anomaly (novel deviation) class 612 (final class label). The images 602 assigned to the NG class 608 with a confidence level that meets the second threshold 616 are assigned to an NG anomaly (abnormal deviation) class 615.

Referring to FIG. 6B, the same images 602 are classified using a binary classifier. As in FIG. 6A, images 602-1 to 602-12 have been classified into an OK class 604 with an associated confidence level 606a and images 602-13 to 602-20 have been classified into an NG class 608 with an associated confidence level 606b.

A subset of the images 602 classified in the NG class 608 form group 617. These images 602 are within the higher range of confidence for the NG class, and thus they are abnormal deviations. Note that FIG. 6B binary classifier does not have a criterion on how to deal with data points with lower than threshold confidence.

Referring to FIG. 6C, the same images 602 as in FIGS. 6A and 6B have been classified using a one-class classifier. All images 602 have been classified into an OK class 604 with an associated confidence level 606a. The classified images 602 form two groups 630, 632. Group 630 are images classified in the OK class 604 with a lower confidence level and group 632 are images classified in the OK class 604 with a higher confidence level. Note that FIG. 6C is a typical one-class classifier which can report all the samples outside of one class as abnormal.

The pseudo-one class classifier 352 used in FIG. 6A advantageously distinguishes between novel anomalies and known categories of anomalies and further between known categories of anomalies. Conventional binary classifiers cannot distinguish novel anomalies and so necessarily sort all anomalies into one of two categories. Conventional one-class classifiers by definition cannot distinguish between and among multiple classes of anomalies and so sort all anomalies into a single known category and a novel category. The pseudo-one class classifier 352 advantageously overcomes the limitations and disadvantages of known classifiers in providing at least the foregoing functionality.

The pseudo-one class classifier 352 may be created through conversion of a multi-class or binary classifier. Advantageously, the pseudo-one class classifier 352 may be capable of beginning autonomous inspection without an existing sample of defective parts. An amount of good data preferably provided as a sample may vary according to how variable a deviation-free mechanical part may be.

Referring again to FIG. 3, in some embodiments, outputs or data generated by the computer system 300 may be combined or used with other Al visual inspection data generated from the same inspection image 310.

For example, in an embodiment, the inspection image 310 may be input to an object detection component including an object detection model configured to detect and classify objects in the inspection image 310. The detected objects may be described by location data (e.g., bounding box) localizing the detected object in the inspection image 310 and a class label (e.g., defect type or class). The data describing the detected objects may then be compared with data describing anomalies detected via the computer system 300 (e.g., comparing location data, such as bounding box coordinates, to determine overlap between the outputs). In some cases, only anomalies having a certain final class label 362 may be compared to detected objects. The comparison may enable confirmation of detected objects using the anomaly detection output (i.e., to confirm the presence of defects). In some embodiments, the object detection and comparison of object detection outputs and anomaly detection outputs may be performed by the computer system 300. The computer system 300, and the systems and methods of the present disclosure more generally, may be used as part of a combined Al visual inspection system, such as described in PCT Application PCT/CA2022/050100, the contents of which are incorporated by reference herein.

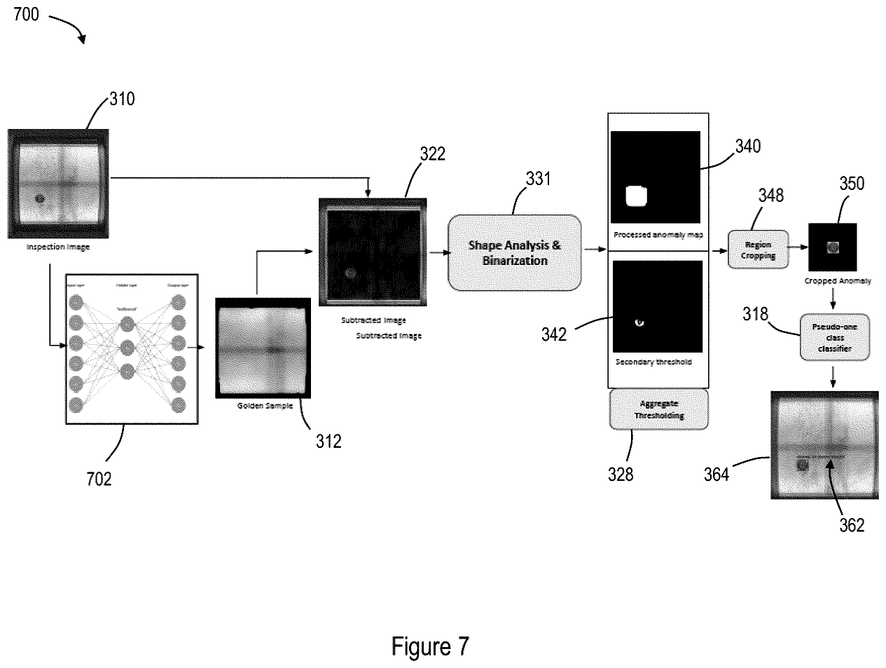

Referring now to FIG. 7, shown therein is an example of an anomaly detection pipeline 700 carried out by the computer system 300 of FIG. 3, according to an embodiment. Additional steps and outputs not shown may be present.

The inspection image 310 is provided to an image subtraction module 320 for comparison with a golden sample image 312. The golden sample image 312 is generated by inputting the inspection image 310 into a generative model 702.

The subtracted image 322 is provided to the shape analysis and binarization module 324.

The SAB output 326 is provided to the aggregate thresholding module 328. The processed primary threshold map 340 and the secondary threshold map 342 are shown. The processed primary and secondary maps 340, 342 are aggregated and the aggregate threshold map 344 (not shown) is used by the adaptive region cropping module 348.

The adaptive region cropping module 348 performs adaptive cropping to generate the cropped image (cropped anomaly) 350. In this particular case, the cropped image 350 has been zero padded. The cropped image 350 is provided to the classification module 318 including a pseudo-one class classifier 352. A second annotated inspection image 364 is generated which includes bounding box data determined from the aggregate thresholding and a final class label 362 determined by the classification module 318.

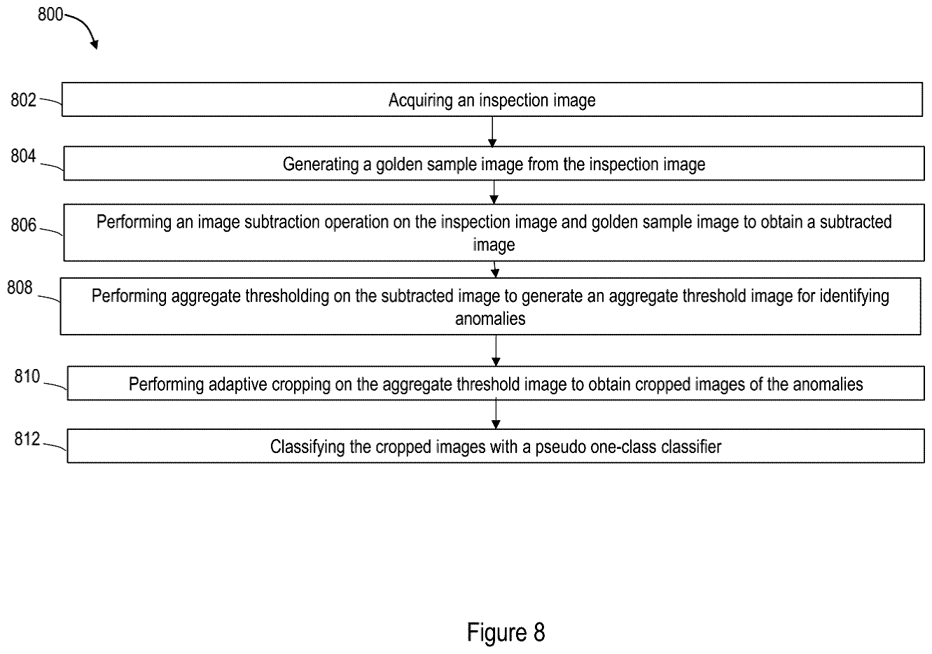

Referring now to FIG. 8, shown therein is a method 800 of visual inspection, according to an embodiment.

At 802, the method 800 includes acquiring an inspection image. The inspection image may be the inspection image 310.

At 804, the method 800 includes generating a golden sample image from the inspection image. The golden sample image may be golden sample image 312.

At 806, the method 800 includes performing an image subtraction operation on the inspection image and golden sample image to obtain subtracted image. The subtracted image may be the subtracted image 322.

At 808, the method 800 includes performing aggregate thresholding on the subtracted image to generate an aggregate threshold image for identifying anomalies. The aggregate threshold map may be the aggregate threshold map 344. The aggregate threshold map may include bounding boxes enclosing each anomaly in the image.

At 810, the method 800 includes performing adaptive cropping on the anomaly map to obtain cropped images of the anomalies in the anomaly map. The cropped images may be cropped image 350 of FIG. 3.

At 812, the method includes classifying the cropped images with a pseudo one-class classifier. The pseudo one-class classifier may be the classification module 318 or the classifier model 352 of FIG. 3.

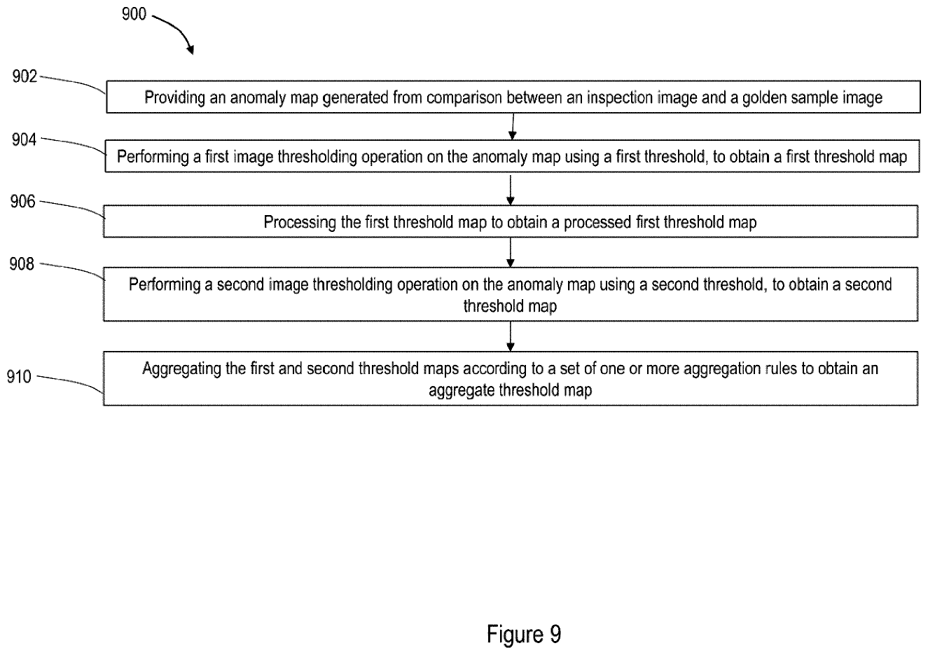

Referring now to FIG. 9, shown therein is a method 900 of aggregate thresholding, according to an embodiment. The method 900 may be used as part of a machine vision anomaly detection method, such as described herein. The method 900 may be performed by the computer system 300 of FIG. 3. In particular, the method 900 may be performed by the aggregate thresholding module 328 of FIG. 3.

At 902, the method 900 includes providing an anomaly map generated from a comparison between an inspection image and a golden sample image. The anomaly map may be the subtracted image 322 of FIG. 3. The comparison may include performing an image subtraction.

At 904, the method 900 includes performing a first image thresholding operation on the anomaly map using a first threshold, to obtain a first threshold map.

At 906, the method 900 includes processing the first threshold map to obtain a processed first threshold map.

At 908, the method 900 includes performing a second image thresholding operation on the anomaly map using a second threshold, to obtain a second threshold map.

The first threshold may be a conservative threshold and the second threshold may be an aggressive threshold.

At 910, the method 900 includes aggregating the first and second threshold maps according to a set of one or more aggregation rules to obtain an aggregate threshold map. In an embodiment, the aggregation rules include keeping, in the aggregate threshold map, any blob that is present in the secondary threshold map that overlaps with a blob present in the processed first threshold map and excluding all other blobs present in the processed first or secondary threshold maps.

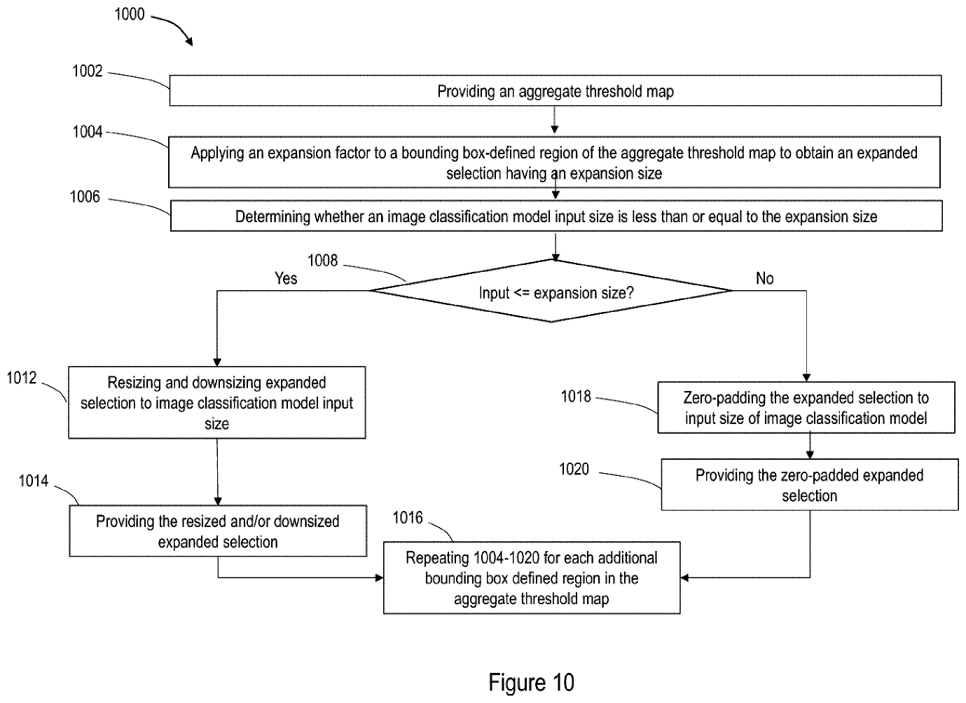

Referring now to FIG. 10, shown therein is a method 1000 of adaptive image region cropping, according to an embodiment. The method 1000 may be used as part of a machine vision anomaly detection process. The method 1000 may be performed by the computer system 300 of FIG. 3. In particular, the method 1000 may be performed by adaptive region cropping module 348 of FIG. 3.

At 1002, the method 1000 includes providing an aggregate threshold map. The aggregate threshold map includes one or more bounding box-defined regions each containing an anomaly (detected via image subtraction and thresholding). The aggregate threshold map may be the aggregate threshold map 344 of FIG. 3. The aggregate threshold map may be provided by the method 900.

At 1004, the method 1000 includes applying an expansion factor to a bounding box-defined region of the aggregate threshold map to obtain an expanded selection having an expansion size.

At 1006, the method 1000 includes determining whether an image classification model input size is less than or equal to the expansion size.

At 1008, the method 1000 branches based on whether the input size of the classifier is less than or equal to the expansion size. If the input size is less than or equal to the expansion size, then the method 1000 proceeds to 1012. If the input size is not less than or equal to the expansion size, then the method 1000 proceeds to 1018.

In some embodiments, after 1008, the method 1000 may include performing collision avoidance using the expanded selection. Collision avoidance may be performed between 1008 and 1012 of method 1000.

At 1012, the method 1000 includes resizing and downsizing the expanded selection to image classification model input size.

At 1014, the method 1000 includes providing the resized and/or downsized expanded selection.

At 1018, the method 1000 includes zero-padding the expanded selection to the input size of image classification model.

At 1020, the method 1000 includes providing the zero-padded expanded selection.

After 1014 or 1020, the method 1000 proceeds to 1016. At 1016, the method includes repeating 1004-1020 for each additional bounding box defined region in the aggregate threshold map.

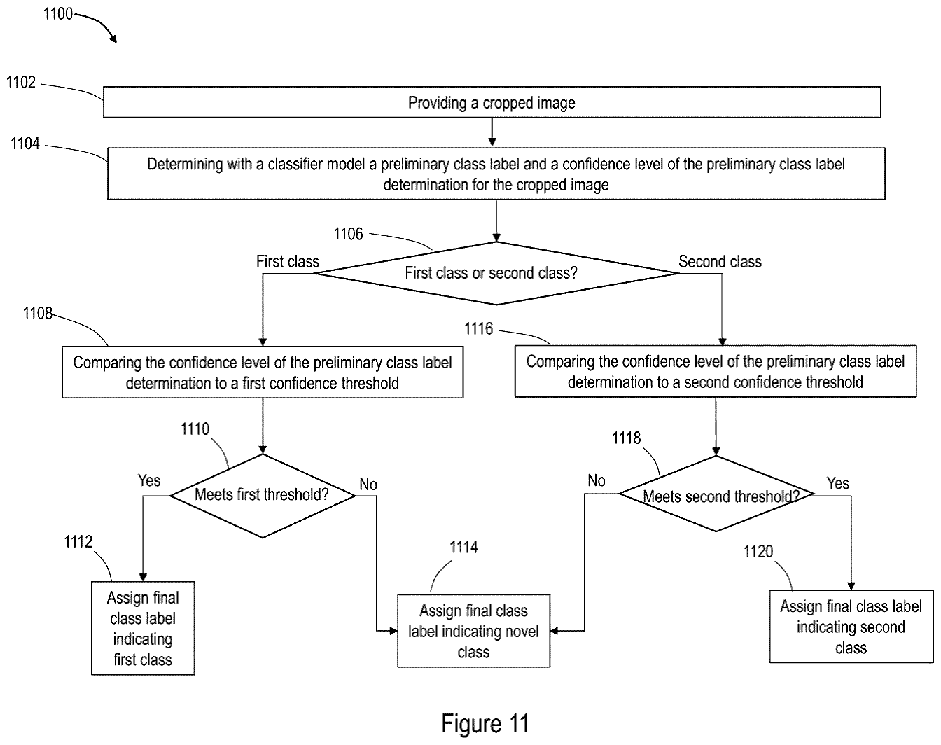

Referring now to FIG. 11, shown therein is a method 1100 of classifying an image, according to an embodiment. The method 1100 may be used as part of a machine vision anomaly detection process. The method 1100 may be performed by the computer system 300 of FIG. 3. In particular, the method 1100 may be performed by the image classification module 318 of FIG. 3 or the classifier model 352 of FIG. 3.

At 1102, the method 1100 includes providing a cropped image. The cropped image may be the cropped image 350. The cropped image may be generated by the method 1000 of FIG. 10.

At 1104, the method 1100 includes determining with a classifier model a preliminary class label and a confidence level of the preliminary class label determination for the cropped image.

At 1106, the method 1100 branches based on whether a first class label or second class label was assigned by the classifier.

If the first label was assigned (e.g., OK class), the method 1100 proceeds to 1108.

If the second label was assigned (e.g., NG class), the method 1100 proceeds to 1116.

At 1108, the method 1100 includes comparing the confidence level of the preliminary class label determination to a first confidence threshold.

At 1110, the method 1100 branches based on whether the confidence level meets the first confidence threshold. If the confidence level meets the first confidence threshold, the method 1100 proceeds to 1112. If the confidence level does not meet the first confidence threshold, the method 1100 proceeds to 1114.

At 1112, the method 1100 includes assigning a final class label indicating a first class assignment (e.g., OK anomaly class).

At 1114, the method 1100 includes assigning a final class label indicating a novel class assignment (e.g., novel anomaly class).

At 1116, the method 1100 includes comparing the confidence level of the preliminary class label determination to a second confidence threshold.

At 1118, the method 1100 branches based on whether the confidence level meets the second confidence threshold. If the confidence level meets the second confidence threshold, the method 1100 proceeds to 1120. If the confidence level does not meet the second confidence threshold, the method 1100 proceeds to 1114.

At 1120, the method 1100 includes assigning a final class label indicating a second class (e.g., NG anomaly class).

At 1114, the method 1100 includes assigning a final class label indicating the novel class assignment (e.g. novel anomaly class).

Following any one or more of the methods 700, 800, 900, 1000, and/or, 1100, post-processing may be performed based on the outputs thereof. For example, parts with anomalies detected and/or confirmed in the aggregate threshold map 344 of FIG. 3 may be discarded, automatically or by a human operator. In a further example, computer resources may be allocated according to the cropped image 350, the allocation created or modified automatically or by a human operator. In a further example, the classification of anomalies according to a final class label as belonging to a first class, a second class, or a novel class in the method 1100 of FIG. 11, may cause a computer system or device implementing the method 1100 (such as the computer system 300 of FIG. 3) or a human operator reviewing the classification to flag parts bearing the classified anomalies for no further review or for further review.

As a further example of post-processing, an anomaly detection device (such as the computer system 300) may send data concerning detected anomalies to a control device (not shown). The control device may generate and further send a control signal to a physical processing component or a physical device. The physical processing component may perform post-processing based on the received control signal. The physical processing component may perform all or some of the post-processing unless the control signal is received. Accordingly, receiving the control signal may advantageously improve efficiency of a computer implementing any of the foregoing functionality and provide a practical application for that foregoing functionality in that the foregoing functionality reduces computer processing.

As a further example of post-processing, the physical processing component may be a physical device (such as a robot) that takes one action when receiving a first control signal. The physical device may take a second action when receiving a second control signal in addition to or instead of taking the second action. Such actions may include refraining from taking particular actions. For example, the physical device may transport or allow the transport of a physical part when receiving a first control signal that all anomalies detected in the part are of the ‘OK’ class but may instead physically discard the part when receiving a second control signal that any anomaly detected in the part is of the ‘NG’ class. The physical device may further flag the part for further review, after transporting or discarding the part, when receiving a third control signal in addition to or instead of the first control signal or the second control signal. The third control signal may be that any anomaly detected in the part is of a novel class (i.e., not ‘OK’ or ‘NG’). The physical device may receive a control signal in respect of each part. The physical device may receive a control signal in respect of each anomaly on or in each part. The physical device may continue performing actions (or refraining from performing actions) in accordance with a last received control signal until a further or different control signal is received. For example, after receiving the second control signal to discard the part, the robot may continue discarding parts until a further or different control signal is received.

In an embodiment, the anomaly detection device, the control device, and the physical device are all separate from one another. Any of the anomaly detection device, the control device, and the physical device may be located remotely to one another. For example, the anomaly detection device and the physical device may both be located physically near the part, and the control device may be located remotely to the anomaly detection device and the physical device. The anomaly detection device, the control device, and the physical device may be located physically near one another, for example all near the part.

While the above description provides examples of one or more apparatus, methods, or systems, it will be appreciated that other apparatus, methods, or systems may be within the scope of the claims as interpreted by one of skill in the art. Claims:

1. A system for inspecting an inspection image, the system comprising:
a memory for receiving or storing the inspection image;
a golden sample generator for generating a golden sample image from the inspection image;
an image subtraction module for generating a subtracted image from the inspection image and the golden sample image;
an aggregate thresholding module for generating an aggregate threshold image for identifying anomalies;
an adaptive region cropping module for obtaining cropped images of the anomalies; and
a cropped image classification module for classifying the cropped images of the anomalies with a pseudo-one-class classifier.

2. The system of claim 1 further comprising a camera configured to capture the inspection image.

3. The system of any one of claims 1-2, wherein the inspection image shows a part or object under inspection or a section of region thereof.

4. The system of any one of claims 1-3, wherein the inspection image is part of a video taken by the camera device.

5. The system of any one of claims 1-4, wherein the inspection image is analyzed for the presence of defects.

6. The system of any one of claims 1-5 further comprising an adaptive ROI segmentation module for masking the inspection image and the golden sample image.

7. The system of any one of claims 1-6 further comprising a shape analysis and binarization module for receiving the subtracted image and generating a shape-analyzed and binarized image.

8. The system of claim 7, wherein the shape analysis and binarization module performs binarization and binary image processing to filter out defects and anomalies smaller than specified and/or caused by minor surface texture variations in the subtracted image.

9. The system of claim 8, wherein the binary image processing includes erosion and delusion.

10. A method of inspecting an inspection image, the method comprising:
acquiring the inspection image;
generating a golden sample image from the inspection image;
performing an image subtraction operation on the inspection image and the golden sample image to obtain a subtracted image;
performing aggregate thresholding on the subtracted image to generate an aggregate threshold image for identifying anomalies;
performing adaptive cropping on the aggregate threshold image to obtain cropped images of the anomalies; and
classifying the cropped images of the anomalies with a pseudo-one-class classifier.

11. The method of claim 10 further comprising annotating the aggregate threshold map.

12. The method of any one of claims 10-11 further comprising discarding parts with anomalies detected and/or confirmed in the aggregate threshold image.

13. The method of any one of claims 10-12, wherein the aggregate threshold map includes a bounding box enclosing each anomaly.

14. The method of claim 13 further comprising identifying each region defined by each bounding box.

15. A device for inspecting an inspection image, the device comprising:
a memory for receiving or storing the inspection image;
a golden sample generator for generating a golden sample image from the inspection image;
an image subtraction module for generating a subtracted image from the inspection image and the golden sample image;
an aggregate thresholding module for generating an aggregate threshold image for identifying anomalies;
an adaptive region cropping module for obtaining cropped images of the anomalies; and
a cropped image classification module for classifying the cropped images of the anomalies with a pseudo-one-class classifier.

16. The device of claim 15, wherein the golden sample image generator includes a generative model.

17. The device of claim 16, wherein the generative model is an autoencoder.

18. The device of claim 17, wherein the autoencoder includes an encoder component for compressing the inspection image to produce a code component and a decoder component for reconstructing the inspection image using the code component.

19. The device of claim 15, wherein the golden sample image generator retrieves an appropriate, pre-stored golden sample image.

20. The device of claim 15, wherein the golden sample image generator receives the golden sample image.

21. A system for aggregate thresholding, the system comprising:
an image subtraction module for generating an anomaly map from comparison between an inspection image and a golden sample image;
a primary threshold map generator for obtaining a first threshold map using a first threshold on the anomaly map;
a processed primary threshold map generator for processing the first threshold map to obtain a processed first threshold map;
a secondary threshold map generator for obtaining a second threshold map using a second threshold on the anomaly map; and
an aggregate threshold map generator for aggregating the first and second threshold maps according to a set of one or more aggregation rules to obtain an aggregate threshold map.

22. The system of claim 21 further comprising a camera configured to capture the inspection image.

23. The system of any one of claims 21-22 further comprising an adaptive ROI segmentation module for masking the inspection image and the golden sample image.

24. The system of any one of claims 21-23 further comprising a shape analysis and binarization module for receiving the subtracted image and generating a shape-analyzed and binarized image by performing binarization and binary image processing to filter out defects and anomalies smaller than specified and/or caused by minor surface texture variations in the subtracted image, wherein the binary image processing includes erosion and delusion.

25. The system of any one of claims 21-24, wherein the first threshold is set by a user.

26. The system of any one of claims 21-25, wherein the second threshold is set by a user.

27. The system of any one of claims 21-26, wherein the first threshold is more conservative than the second threshold.

28. A method for aggregate thresholding, the method comprising:
providing an anomaly map generated from comparison between an inspection image and a golden sample image;
performing a first image thresholding operation on the anomaly map using a first threshold to obtain a first threshold map;
processing the first threshold map to obtain a processed first threshold map;
performing a second image thresholding operation on the anomaly map using a second threshold to obtain a second threshold map; and
aggregating the first and second threshold maps according to a set of one or more aggregation rules to obtain an aggregate threshold map.

29. The method of claim 28 further comprising discarding parts with anomalies detected and/or confirmed in the aggregate threshold image.

30. The method of any one of claims 28-29, wherein the aggregate threshold map includes a bounding box enclosing each anomaly.

31. The method of any one of claims 28-30, wherein the first threshold is set by a user.

32. The method of any one of claims 28-31, wherein the second threshold is set by a user.

33. The method of any one of claims 28-32, wherein the first threshold is more conservative than the second threshold.

34. A device for aggregate thresholding, the device comprising:
an image subtraction module for generating an anomaly map from comparison between an inspection image and a golden sample image;
a primary threshold map generator for obtaining a first threshold map using a first threshold on the anomaly map;
a processed primary threshold map generator for processing the first threshold map to obtain a processed first threshold map;
a secondary threshold map generator for obtaining a second threshold map using a second threshold on the anomaly map; and
an aggregate threshold map generator for aggregating the first and second threshold maps according to a set of one or more aggregation rules to obtain an aggregate threshold map.

35. The device of claim 34, wherein the golden sample image generator includes a generative model, wherein the generative model is an autoencoder including an encoder component for compressing the inspection image to produce a code component and a decoder component for reconstructing the inspection image using the code component.

36. The device of claim 34, wherein the golden sample image generator retrieves an appropriate, pre-stored golden sample image.

37. The device of claim 34, wherein the golden sample image generator receives the golden sample image.

38. The device of any one of claims 34-37, wherein the first threshold is set by a user.

39. The device of any one of claims 34-38, wherein the second threshold is set by a user.

40. The device of any one of claims 34-39, wherein the first threshold is more conservative than the second threshold.

41. A system for adaptive region cropping, the system comprising:
an adaptive cropping region module for receiving an aggregate threshold map based on an inspection image, the adaptive cropping region module comprising or implemented on a processor and a memory having computer-executable instructions stored thereon that, when executed, cause the processor to perform the following operations:
for each bounding box-defined region in the aggregate threshold map:
applying an expansion factor to the bounding box-defined region to obtain an expanded selection having an expansion size;
where an image classification model input size of an image classification model is less than or equal to the expansion size:
resizing and downsizing an expanded selection to the image classification model input size; and
providing the resized and/or downsized expanded selection as input to the image classification model;
where the image classification model input size is not less than or equal to the expansion size:
zero-padding the expanded selection to the image classification model input size; and
providing the zero-padded expanded selection as input to the image classification model.

42. The system of claim 41, wherein the expansion factor is: expansion size=(16^{(length-input)/(0.88*input)}+1)×length, wherein ‘input’ refers to the image classification model input size.

43. The system of any one of claims 41-42, wherein resizing and downsizing proceed according to the formula: Cropping size=min(input, expansion size), wherein ‘input’ refers to the image classification model input size.

44. The system of any one of claims 41-43 further comprising a collision avoidance module for limiting cropping coordinates to remain inside the inspection image.

45. The system of any one of claims 41-44 further comprising a down-sampling module for down-sampling the aggregate threshold map when an anomaly blob shown therein is larger than the image classification model input size.

46. The system of claim 45, wherein the aggregate threshold map includes bounding boxes enclosing each anomaly blob.

47. The system of any one of claims 41-46, wherein the inspection image is captured by a camera.

48. A method for adaptive region cropping, the method comprising:
providing an aggregate threshold map;
for each bounding box-defined region in the aggregate threshold map based on an inspection image:
applying an expansion factor to the bounding box-defined region to obtain an expanded selection having an expansion size;
where an image classification model input size of an image classification model is less than or equal to the expansion size:
resizing and downsizing an expanded selection to the image classification model input size;
providing the resized and/or downsized expanded selection as input to the image classification model;
where the image classification model input size is not less than or equal to the expansion size:
zero-padding the expanded selection to the image classification model input size; and
providing the zero-padded expanded selection to the image classification model.

49. The method of claim 48, wherein the expansion factor is: expansion size=(16^{(length-input)/(0.88*input)}+1)×length, wherein ‘input’ refers to the image classification model input size.

50. The method of any one of claims 48-49, wherein resizing and downsizing proceed according to the formula: Cropping size=min(input, expansion size), wherein ‘input’ refers to the image classification model input size.

51. The method of any one of claims 48-50 further comprising performing collision avoidance by limiting cropping coordinates to remain inside the inspection image.

52. The method of any one of claims 48-51 further comprising down-sampling the aggregate threshold map when an anomaly blob shown therein is larger than the image classification model input size.

53. The method of claim 52, wherein the aggregate threshold map includes bounding boxes enclosing each anomaly blob.

54. The method of any one of claims 48-53, wherein the inspection image is captured by a camera.

55. A device for adaptive region cropping, the device comprising:
an adaptive cropping region module for receiving an aggregate threshold map based on an inspection image, the adaptive cropping region module comprising or implemented on a processor and a memory having computer-executable instructions stored thereon that, when executed, cause the processor to perform the following operations:
for each bounding box-defined region in the aggregate threshold map:
applying an expansion factor to the bounding box-defined region to obtain an expanded selection having an expansion size;
where an image classification model input size of an image classification model is less than or equal to the expansion size:
resizing and downsizing an expanded selection to the image classification model input size;
providing the resized and/or downsized expanded selection as input to the image classification model;
where the image classification model input size is not less than or equal to the expansion size:
zero-padding the expanded selection to the image classification model input size; and
providing the zero-padded expanded selection as input to the image classification model.

56. The device of claim 55, wherein the expansion factor is: expansion size=(16^{(length-input)/(0.88*input)}+1)×length, wherein ‘input’ refers to the image classification model input size.

57. The device of any one of claims 55-56, wherein resizing and downsizing proceed according to the formula: Cropping size =min(input, expansion size), wherein ‘input’ refers to the image classification model input size.

58. The device of any one of claims 55-57 further comprising a collision avoidance module for limiting cropping coordinates to remain inside the inspection image.

59. The device of any one of claims 55-58 further comprising a down-sampling module for down-sampling the aggregate threshold map when an anomaly blob shown therein is larger than the image classification model input size.

60. The device of claim 59, wherein the aggregate threshold map includes bounding boxes enclosing each anomaly blob.

61. A system for classifying an input image according to a pseudo-one-class classifier, the system comprising:
a cropped image classification module comprising a classifier model, the cropped image classification module comprising or implemented on a processor and a memory having computer-executable instructions stored thereon that, when executed, cause the processor to perform the following operations:
receiving a cropped image;
determining with the classifier model a preliminary class label and a confidence level associated with the preliminary class label determination for the cropped image;
where the preliminary class label is of a first class:
comparing the confidence level of the preliminary class label determination to a first confidence threshold;
where the confidence level meets the first confidence threshold:
assigning a final class label to the cropped image indicating the first class;
where the confidence level does not meet the first confidence threshold:
assigning a final class label to the cropped image indicating a novel class;
where the preliminary class label is of a second class:
comparing the confidence level of the preliminary class label determination to a second confidence threshold:
where the confidence level meets the second confidence threshold:
assigning a final class label to the cropped image indicating the second class;
where the confidence level does not meet the second confidence threshold:
assigning a final class label to the cropped image indicating the novel class.

62. The system of claim 61, wherein the first confidence level is set by a user.

63. The system of any one of claims 61-62, wherein the second confidence level is set by a user.

64. The system of any one of claims 61-63, wherein the image classifier model is a convolutional neural network.

65. The system of any one of claims 61-64, wherein the first class represents normal deviations, the second class represents abnormal deviations, and the novel class represents novel deviations.

66. The system of any one of claims 61-65, wherein meeting a confidence level includes equaling the confidence level and further includes exceeding the confidence level.

67. The system of any one of claims 61-65, wherein meeting a confidence level includes exceeding the confidence level and does not include equaling the confidence level.

68. A method of classifying an input image according to a pseudo-one class classifier, the method comprising:
providing a cropped image;
determining with a classifier model a preliminary class label and a confidence level associated with the preliminary class label determination for the cropped image;
where the preliminary class label is of a first class:
comparing the confidence level of the preliminary class label determination to a first confidence threshold;
where the confidence level meets the first confidence threshold:
assigning a first final class label to the cropped image indicating the first class;
where the confidence level does not meet the first confidence threshold:
assigning a second final class label to the cropped image indicating a novel class;
where the preliminary class label is of a second class:
comparing the confidence level of the preliminary class label determination to a second confidence threshold:
where the confidence level meets the second confidence threshold:
assigning a third final class label to the cropped image indicating the second class;
where the confidence level does not meet the second confidence threshold:
assigning the second final class label to the cropped image indicating the novel class.

69. The method of claim 68, wherein the first confidence level is set by a user.

70. The method of any one of claims 68-69, wherein the second confidence level is set by a user.

71. The method of any one of claims 68-70, wherein meeting a confidence level includes equaling the confidence level and further includes exceeding the confidence level.

72. The method of any one of claims 68-70, wherein meeting a confidence level includes exceeding the confidence level and does not include equaling the confidence level.

73. The method of any one of claims 68-72 further comprising generating a second annotated inspection image using the final class label.

74. The method of any one of claims 68-73 further comprising flagging parts for review based on the final class label.

75. A device for classifying an input image according to a pseudo-one-class classifier, the device comprising:
a cropped image classification module comprising a classifier model, the cropped image classification module comprising or implemented on a processor and a memory having computer-executable instructions stored thereon that, when executed, cause the processor to perform the following operations:
receiving a cropped image;
determining with the classifier model a preliminary class label and a confidence level associated with the preliminary class label determination for the cropped image;
where the preliminary class label is of a first class:
comparing the confidence level of the preliminary class label determination to a first confidence threshold;
where the confidence level meets the first confidence threshold:
assigning a final class label to the cropped image indicating the first class;
where the confidence level does not meet the first confidence threshold:
assigning a final class label to the cropped image indicating a novel class;
where the preliminary class label is of a second class:
comparing the confidence level of the preliminary class label determination to a second confidence threshold:
where the confidence level meets the second confidence threshold:
assigning a final class label to the cropped image indicating the second class;
where the confidence level does not meet the second confidence threshold:
assigning a final class label to the cropped image indicating the novel class.

76. The device of claim 75, wherein the first confidence level is set by a user.

77. The device of any one of claims 75-76, wherein the second confidence level is set by a user.

78. The device of any one of claims 75-77, wherein meeting a confidence level includes equaling the confidence level and further includes exceeding the confidence level.

79. The device of any one of claims 75-78, wherein meeting a confidence level includes exceeding the confidence level and does not include equaling the confidence level.

80. The device of any one of claims 75-79, wherein the image classifier model is a convolutional neural network.
